(19) United States
(12) Patent Application Publication
(10) Pub. No.: US 2011/0082870 A1
(43) Pub. Date: Apr. 7, 2011

(54) INFORMATION PROCESSING APPARATUS AND METHOD

(76) Inventors: Junichi OGIKUBO, Kanagawa (JP); Yasuhiro ICHINAKA, Kanagawa (JP); Shigeru OHWADA, Kanagawa (JP)

(21) Appl. No.: 12/889,915

(22) Filed: Sep. 24, 2010

(30) Foreign Application Priority Data
Oct. 2, 2009 (JP) P2009-230942

(51) Int. Cl. G06F 17/30

(52) U.S. Cl. 707/756; 707/E17.044

(57) ABSTRACT

Provided is an information processing apparatus including: an input metadata table acquisition unit which acquires an input metadata table which is a list of items included in a metadata before format conversion; an output metadata table acquisition unit which acquires an output metadata table which is a list of items included in a metadata after the format conversion; and a user map template generation unit which generates a user map template which is a template of a conversion pattern of each item of the metadata, which is used for a conversion process of converting the format of the metadata by performing linking between the items included in the input metadata table acquired by the input metadata table acquisition unit and the items included in the output metadata table acquired by the output metadata table acquisition unit.

### BACKGROUND OF THE INVENTION

1. Field of the Invention

The present invention relates to an information processing apparatus and method, and more particularly, to an information processing apparatus and method capable of easily and appropriately performing conversion of metadata.

2. Description of the Related Art

Recently, various methods of providing and delivering contents including video or audio have been provided. Accordingly, various standards of contents have also been made.

For example, the standards of the formats of the contents have been defined according to various uses such as distribution in the state where the contents are recorded on a recording medium such as a DVD or a CD, delivery via a network such as the Internet, transmission to a portable electronic apparatus, terrestrial digital broadcasting, satellite broadcasting, or showing at a theater.

As the variety of contents has increased, at the sites where the contents are generated, transcoding (conversion) of various formats may have to be provided. Therefore, systems of performing conversion of the formats of the multimedia contents have been developed (for example, refer to Japanese Unexamined Patent Application Publication (Translation of PCT Application) No. 2003-527005 and Japanese Unexamined Patent Application Publication Nos. 2002-44622 and 2002-77855).

### SUMMARY OF THE INVENTION

However, in the systems in the related art, the conversion of the metadata included in the contents may have to be performed manually. Therefore, complicated tasks may have to be performed.

It is desirable to easily and appropriately perform conversion of a metadata.

In a first embodiment of the invention, there are provided an information processing apparatus including: an input metadata table acquisition unit which acquires an input metadata table which is a list of items included in a metadata before format conversion; an output metadata table acquisition unit which acquires an output metadata table which is a list of items included in a metadata after the format conversion; and a user map template generation unit which generates a user map template which is a template of a conversion pattern of each item of the metadata, which is used for a conversion process of converting the format of the metadata by performing linking between the items included in the input metadata table acquired by the input metadata table acquisition unit and the items included in the output metadata table acquired by the output metadata table acquisition unit.

It is preferable that the user map template generation unit generates the user map template by performing the linking on items of the input metadata table designated by a user and items of the output metadata table designated by the user according to an instruction of the user.

It is preferable that the information processing apparatus may further include an item editing unit which performs item editing with respect to the input metadata table acquired by the input metadata table acquisition unit or the output metadata table acquired by the output metadata table acquisition unit.

It is preferable that the user map template generation unit generates the user map template by performing the linking of the items by using an automatic map template which is a template in which a conversion pattern of each item of the metadata is defined in advance.

It is preferable that the user map template generation unit generates the user map template by performing the linking of the items by using the existing user map template.

It is preferable that the information processing apparatus may further include: a family tree acquisition unit which acquires family tree information representing a structure of a conversion process which converts a format of a clip; and a metadata acquisition unit which acquires a metadata of a clip which is designated by using the family tree information acquired by the family tree acquisition unit, wherein the user map template generation unit generates the user map template by performing the linking between values of the items included in the metadata acquired by the metadata acquisition unit and the items included in the output metadata table acquired by the output metadata table acquisition unit.

It is preferable that the information processing apparatus may further include a display control unit allows the items included in the input metadata table acquired by the input metadata table acquisition unit, the items included in the output metadata table acquired by the output metadata table acquisition unit, and the conversion pattern represented by the user map template generated by the user map template generation unit.

In a second embodiment of the invention, there are provided an information processing method including the steps of: acquiring an input metadata table which is a list of items included in a metadata before format conversion; acquiring an output metadata table which is a list of items included in a metadata after the format conversion; and generating a user map template which is a template of a conversion pattern of each item of the metadata, which is used for a conversion process of converting the format of the metadata by performing linking between the items included in the input metadata table acquired by the input metadata table acquisition unit and the items included in the output metadata table acquired by the output metadata table acquisition unit.

In a third embodiment of the invention, there are provided an information processing apparatus including: a map template acquisition unit which acquires a map template which is a template of a conversion pattern of each item of a metadata corresponding to formats before and after conversion of a conversion process, which converts a format of the metadata; and a conversion unit which converts the format of the metadata by using the map template acquired by the map template acquisition unit.

It is preferable that the map template acquisition unit acquires an automatic map template which is a template in which a conversion pattern of each item of the metadata is defined in advance.

It is preferable that the map template acquisition unit acquires a user map template which is a template in which a conversion pattern of each item of the metadata is defined by a user.

In a fourth embodiment of the invention, there are provided an information processing method including the steps of: acquiring a map template which is a template of a conversion pattern of each item of a metadata corresponding to formats before and after conversion of a conversion process, which converts a format of the metadata; and converting the format of the metadata by using the map template acquired by the map template acquisition unit.

In a fifth embodiment of the invention, there are provided a configuration where an input metadata table which is a list of items included in a metadata before format conversion is acquired; an output metadata table which is a list of items included in a metadata after the format conversion is acquired; and a user map template, which is a template of a conversion pattern of each item of the metadata which is used for a conversion process of converting the format of the metadata, is generated by performing linking between the items included in the input metadata table and the items included in the output metadata table.

In a sixth embodiment of the invention, there are provided a configuration where a map template which is a template of a conversion pattern of each item of a metadata corresponding to formats before and after conversion of a conversion process of converting a format of the metadata is acquired; and the format of the metadata is converted by using the acquired map template.

According to the invention, it is possible to convert the format. Particularly, it is possible to easily and appropriately perform the metadata conversion.

### BRIEF DESCRIPTION OF THE DRAWINGS

FIG. 1 is a block diagram illustrating an example of a main configuration of a conversion system according to the invention.

FIG. 2 is a diagram illustrating behavior of transcoding of multi-formats.

FIG. 3 is a diagram illustrating an example of metadata.

FIG. 4 is a diagram continued from FIG. 3, illustrating the example of metadata.

FIG. 5 is a diagram continued from FIG. 4, illustrating the example of metadata.

FIG. 6 is a block diagram illustrating an example of a main configuration of a remote client of FIG. 1.

FIG. 7 is a block diagram illustrating an example of a main configuration of a multi-format transcoder of FIG. 1.

FIG. 8 is a function block diagram illustrating functions of devices.

FIG. 9 is a diagram illustrating an example of main function blocks associated with user map template generation.

FIG. 10 is a diagram illustrating an example of display of GUI of metadata mapping.

FIG. 11 is a diagram illustrating an example of a format conversion structure.

FIG. 12 is a diagram illustrating an example of display of GUI of conversion management information.

FIG. 13 is a flowchart illustrating an example of a flow of a user map template generation process.

FIG. 14 is a flowchart continued from FIG. 13, illustrating the example of the flow of the user map template generation process.

FIG. 15 is a flowchart continued from FIG. 14, illustrating the example of the flow of the user map template generation process.

FIG. 16 is a flowchart continued from FIG. 15, illustrating the example of the flow of the user map template generation process.

FIG. 17 is a diagram illustrating an example of main function blocks associated with use of a user map template.

FIG. 18 is a diagram illustrating an example of display of GUI of transcoding.

FIG. 19 is a flowchart illustrating an example of a flow of a conversion process.

FIG. 20 is a flowchart continued from FIG. 19, illustrating the example of the flow of the conversion process.

FIG. 21 is a diagram illustrating an example of main function blocks associated with multi-task execution management.

FIG. 22 is a flowchart illustrating an example of a flow of a task management process.

FIG. 23 is a diagram illustrating an example of behavior of multi-task management.

FIG. 24 is a diagram illustrating an example of behavior of multi-task parallel execution.

### DESCRIPTION OF THE PREFERRED EMBODIMENTS

Hereinafter, embodiments carrying out the invention (hereinafter, referred to as embodiments) are described. In addition, the description is made in the following order.

1. First Embodiment (Conversion System)

### <1. First Embodiment>

### [Configuration of Conversion System]

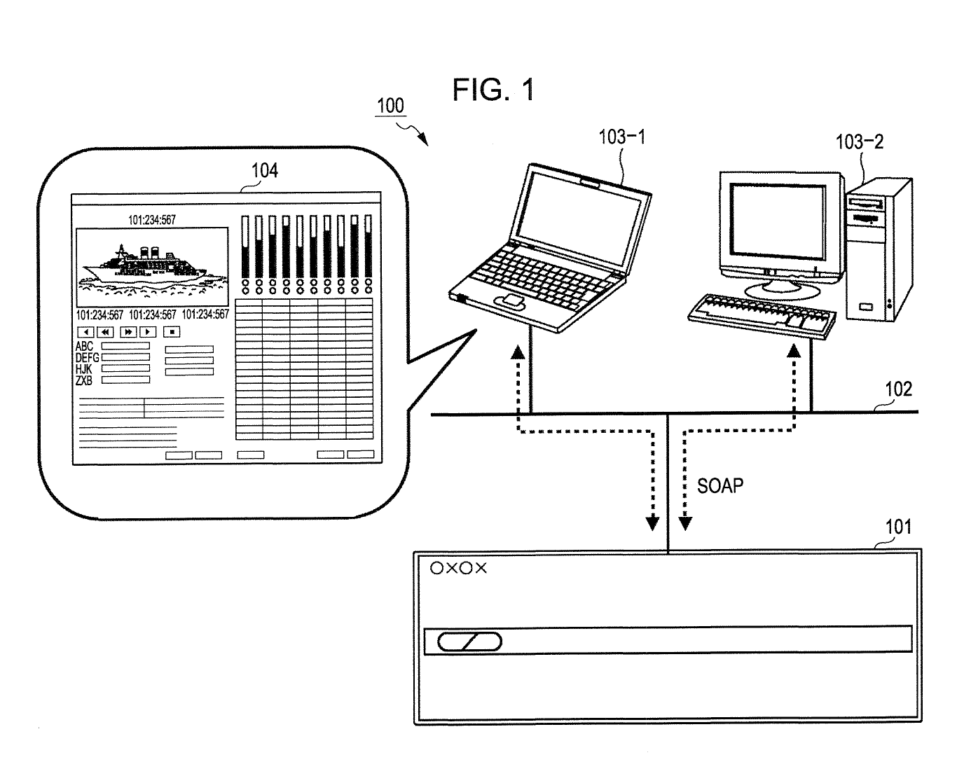

FIG. 1 illustrates a configuration of a conversion system according to an embodiment of the invention.

In FIG. 1, a conversion system 100 is an information process system which converts (transcodes) a format of multimedia contents including video or audio.

As illustrated in FIG. 1, the conversion system 100 includes a multi-format transcoder 101, a remote client 103-1, and a remote client 103-2, which are connected to each other via a network 102.

The multi-format transcoder 101 is a processing apparatus which transcodes (converts) a format of contents. The multi-format transcoder 101 may process multimedia contents including video or audio.

Although individual subject-matter data such as video or audio included in contents are configured as individual files, the multi-format transcoder 101 manages and processes the subject-matter data as one subject matter. In this manner, a set of the subject-matter data, the metadata, or the like that are considered to be one subject matter by the multi-format transcoder 101 is referred to as a clip.

The clip may be configured to include arbitrary data. Hereinafter, for the convenience of description, the clip is assumed to include a video data, an audio data, a proxy data (low resolution data) in which a video of the video data is configured at a low resolution, or a metadata on the contents or each data. All the data may not have to be included in the clip. In addition, other data may be included in the clip.

In addition, the metadata includes information on the contents or the data. The metadata includes, for example, a name of contents, a number of scene or take, a time code of IN point OUT point, a duration, a generation date, an updating date, a memorandum and a comment at the time of photographing such as a location or weather, or the like. In addition to this, any information may be included, and the information may not included.

Various standards for the clip are provided according to the use, and various formats exist. According to the formats, the format of each data (each file) included in the clip may be different, and the information included in each data may be different. The multi-format transcoder 101 performs a process (transcode) of converting the format of the clip to a different format.

The multi-format transcoder 101 is controlled by the remote client 103-1 or the remote client 103-2 via the network 102 which is represented by the Internet, a LAN (Local Area Network), or the like.

The remote client 103-1 and the remote client 103-2 perform communication with the multi-format transcoder 101 by using a SOAP (Simple Object Access Protocol) to control operations of the multi-format transcoder 101. In addition, a protocol other than the SOAP may be used.

In the case where the remote client 103-1 and the remote client 103-2 may not have to be distinguished in the description, the remote clients are simply referred to as remote clients 103. In the conversion system 100, there are provided an arbitrary number of the remote clients 103. In addition, the remote client 103 may be an electronic apparatus which may communicate with the multi-format transcoder 101 via the network 102 and which may control the multi-format transcoder 101. For example, the remote client 103 may be a mobile apparatus such as a notebook type personal computer or a mobile phone or a stationary type electronic apparatus such as a desk type personal computer or a hard disk recorder.

A GUI (Graphical User Interface) 104 for receiving a manipulation of controlling the multi-format transcoder 101 is displayed on a monitor of the remote client 103, and a user input the manipulation over the GUI 104 to the remote client 103. The remote client 103 supplies the input user instruction to the multi-format transcoder 101 via the network 102 to control the operations of the multi-format transcoder 101.

If the network 102 is a communication medium between the multi-format transcoder 101 and the remote client, it may have an arbitrary configuration. For example, it may be a wired communication network, a wireless communication network, or a combination thereof. In addition, the network 102 may be configured with a plurality of networks.

In addition, the conversion system 100 may be configured to include a plurality of the multi-format transcoders 101.

### [Overview of Transcode]

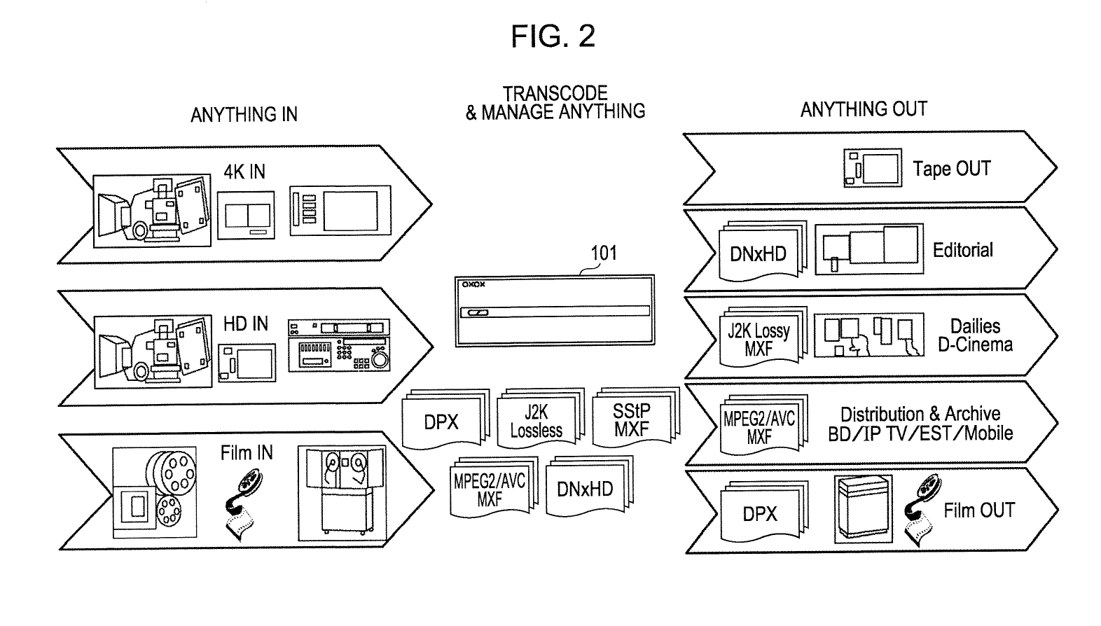

Now, the overview of the transcoding of the multi-format transcoder 101 is described. FIG. 2 is a diagram illustrating behavior of the transcoding of the multi-formats.

The multi-format transcoder 101 may include an encoder or a decoder in an arbitrary standard, so that it may perform transcoding (conversion process) between arbitrary formats.

For example, as illustrated in FIG. 2, the multi-format transcoder 101 may perform the conversion process on the format such as MXF (Material exchange Format) or DNxHD, which is a business video file format using DPM (Digital Picture Exchange), Lossless JPEG (Joint Photographic Experts Group) 2000, MPEG (Moving Picture Experts Group) 2, AVC (Advanced Video Coding), or the like.

In addition, the multi-format transcoder 101 transcodes (converts) the format of the clip. In other words, the transcoding includes all the conversion processes with respect to the format conversion such as a change in, for example, a picture size, an aspect ratio, or a frame rate, burning of a time code, a title, or the like, re-encoding of a subject-matter data such as video or audio, updating of contents of, for example, a metadata, or the like.

The multi-format transcoder 101 registers and manages a group of files (digital data) constituting the contents as a clip and sets the registered clip as an object of the transcoding. In other words, the multi-format transcoder 101 sets the files (digital data), which are registered as a clip, as an object of the transcoding process.

However, the multi-format transcoder 101 has a function (ingest function) of digitalizing contents having an arbitrary form and registering as a clip. Therefore, the forms of the input contents are arbitrary (Anything In).

For example, as illustrated in FIG. 2, the input contents may be multimedia contents including a so-called 4K video having 4096×2160 dots used for a digital cinema, or the like or multimedia contents including an HD (High-Definition) image having 1920×1080 dots. The data may be transmitted to the multi-format transcoder 101 via the network 102 or may be supplied to the multi-format transcoder 101 in a state where the data are recorded on a recording medium such as an optical disk or a flash memory. In addition, the data may not be a digital data such as a film video.

Similarly, the multi-format transcoder 101 has a function of converting a digital data to contents having an arbitrary form. Therefore, the forms of the output contents are arbitrary (Anything Out).

For example, the multi-format transcoder 101 may output the clip after the conversion as a VTR (Tape OUT), data for editing, contents of a digital cinema, contents in a standard for distribution or storing, or a film video.

In this manner, in addition to transcoding an arbitrary format to another arbitrary format, the multi-format transcoder 101 manages the information (conversion management information) on the transcoding (Transcode & Manage Anything).

The multi-format transcoder 101 makes a database of the conversion management information, for example, contents of the transcoding (conversion parameters) or information (metadata or the like) on the clips (or files) before and after the conversion and manages the database. In addition, the multi-format transcoder 101 make a database of the conversion management information such as information representing the behavior (structure) of the transcode, that is, a transcode family pedigree (family tree) which is information representing which clip (file) is generated from which clip (file) and manages the database.

### [Metadata]

As described above, when the multi-format transcoder 101 transcodes the format of the clip, the multi-format transcoder 101 also performs the conversion of the metadata. In general, the content of the metadata is different according to the format.

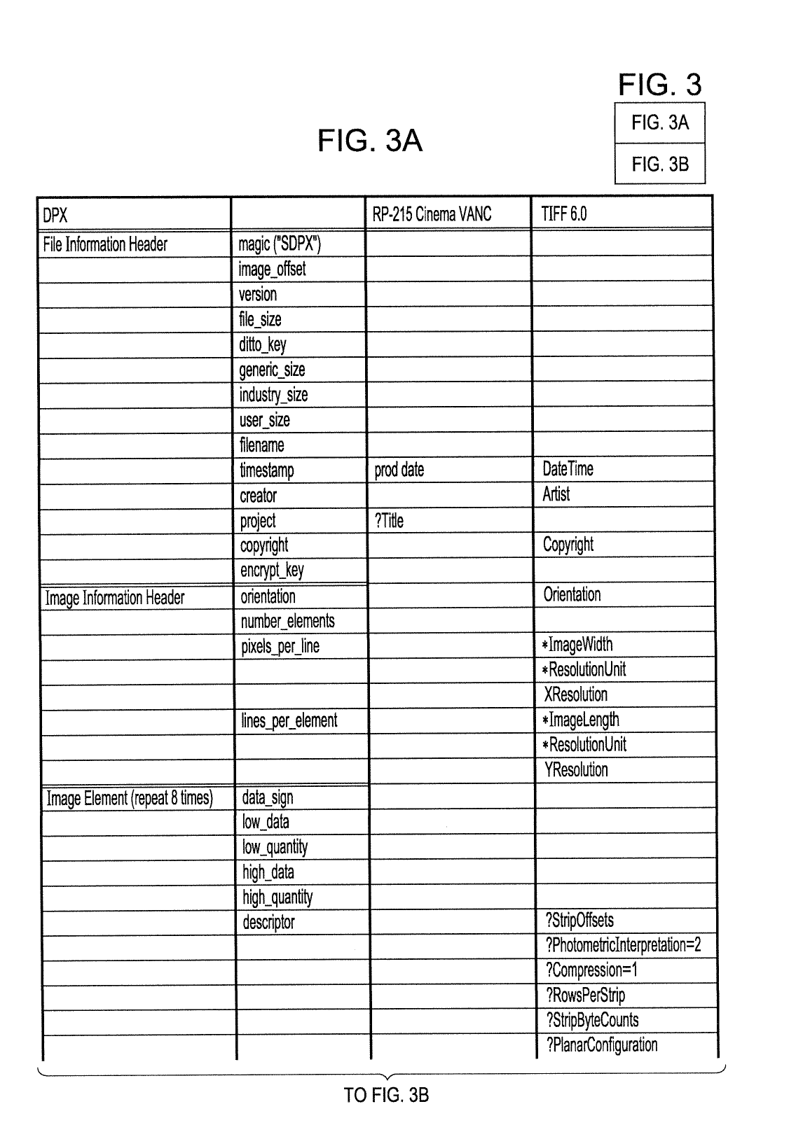

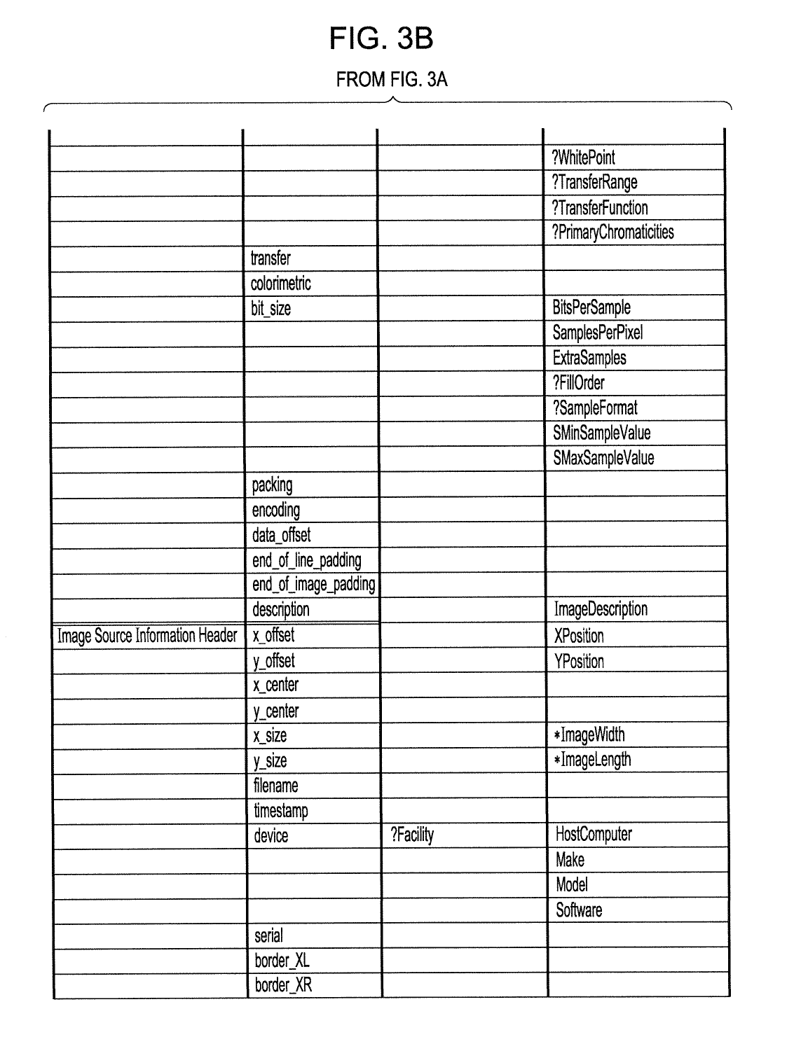

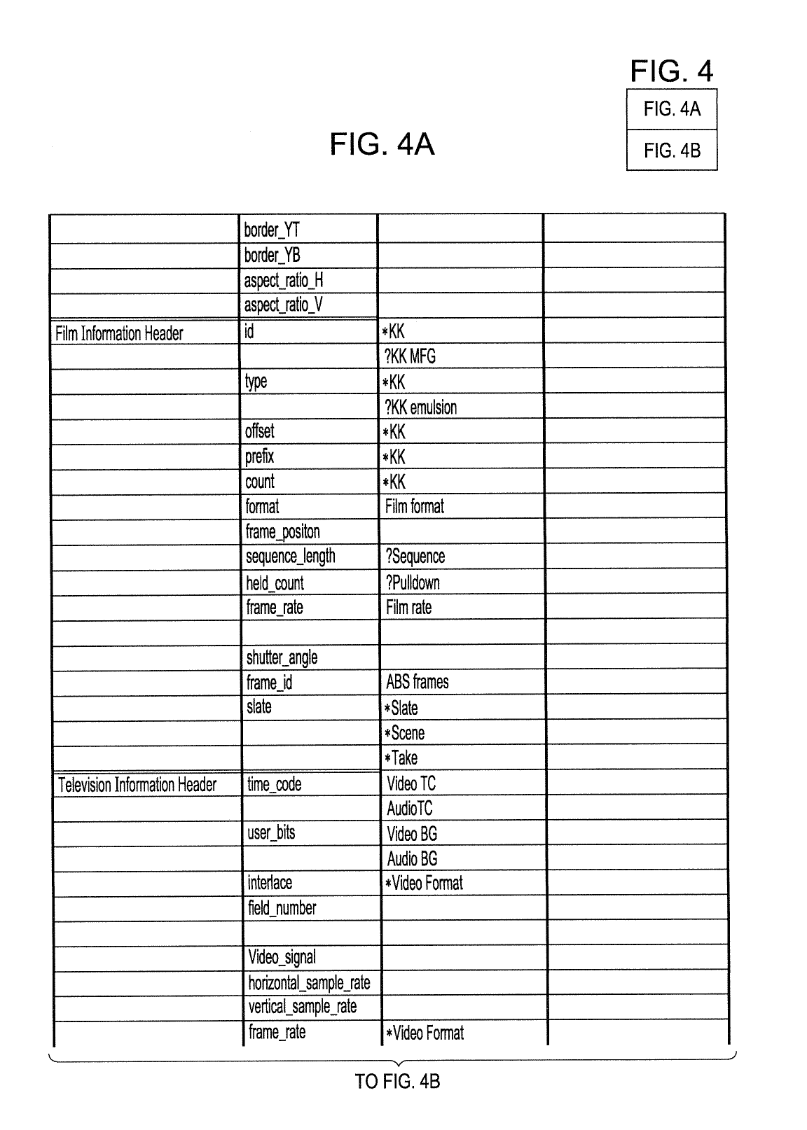

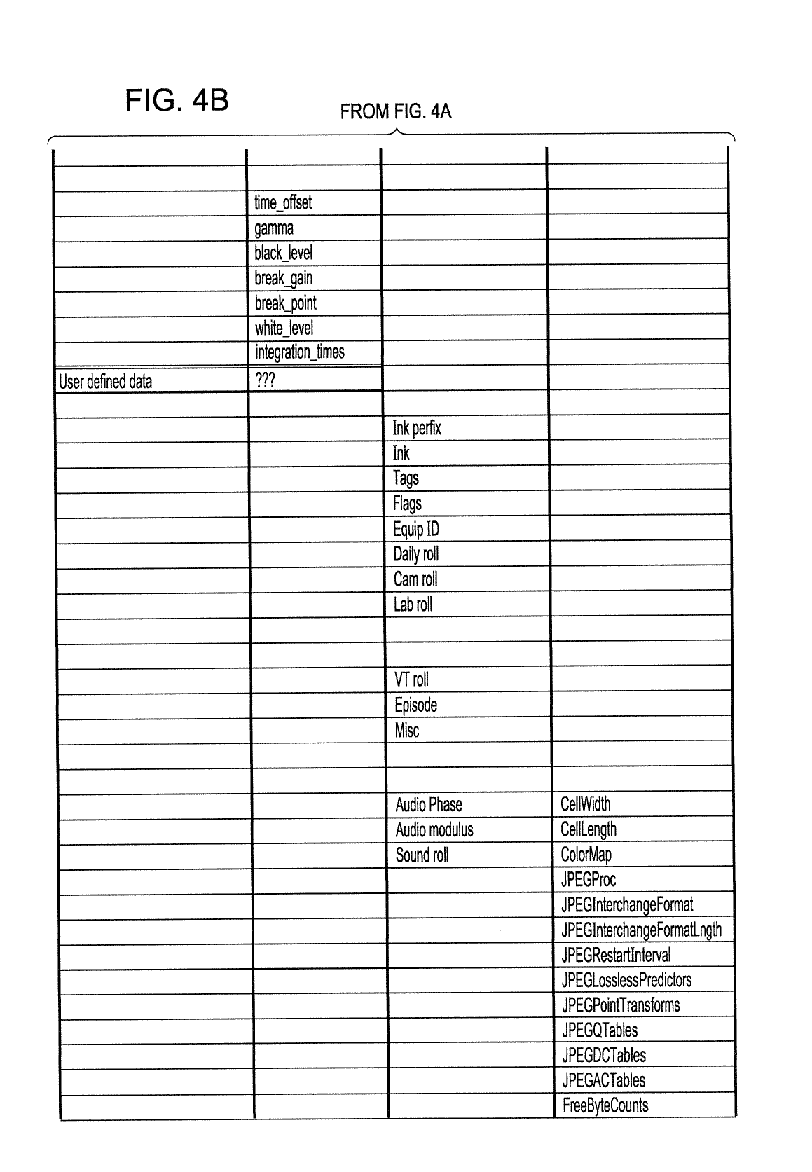

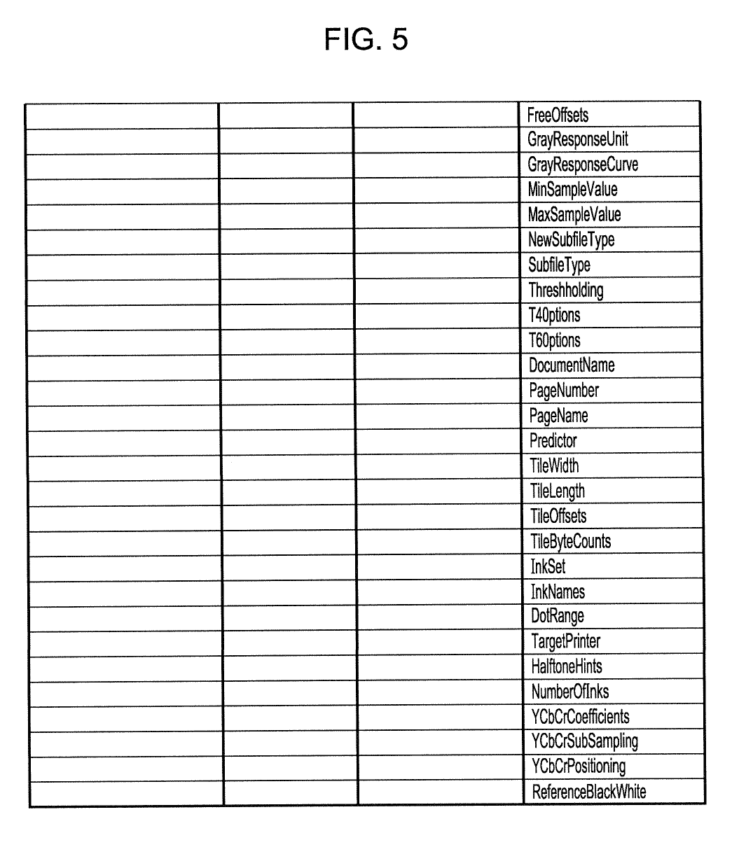

Examples of the metadata of the clip are illustrated in FIGS. 3 to 5. In FIGS. 3 to 5, contents (items) of the metadata having three formats of DPX (Digital Picture Exchange), RP-215 Cinema Vanc, and TIFF (Tagged Image File Format) 6.0 are illustrated.

As illustrated in FIGS. 3 to 5, basically, all items of the metadata may not have to be coincident with each other between formats. Therefore, if the items of the metadata of the format before the conversion are allowed to be simply inherited to the metadata of the format after the conversion, the mismatching items are not inherited but removed, an information amount of the metadata is decreased.

In addition, even the item having the same contents may have different item names for each format. Therefore, only the simple inheritance of the items may not enable the items, of which the item names mismatch, to be inherited.

Therefore, there may be considered a method where the user manually performs the linking (mapping) between the items of the metadata before the conversion and the items of the metadata after the conversion and performs the inheritance according to the mapping.

However, since the number of the items of the metadata is very large as illustrated in FIGS. 3 to 5, in this manner, the user may have to perform complicated tasks.

The multi-format transcoder 101 provides a template (map template) of a pattern (map) of linking of the items of the metadata between the formats before and after the conversion. Since the multi-format transcoder 101 performs the inheritance of the items of the metadata by using the map template, the user may easily suppress a decrease in data amount of the metadata due to the mismatching of the items (or item names) at the time of the transcoding.

However, since the items of the metadata are basically different according to the format, all the items may not be inherited by using even the map template. In addition, there may be considered a case where a change in the pattern of the linking (mapping) of the items by the transcoding is desired. In addition, there may also be considered a case where a change in the pattern of the linking (mapping) of the items is desired by each user.

For example, in the case of generating the contents, even in the transcoding between the same formats, the change in the contents of the metadata between the pilot production and the delivery may be considered. In addition, for example, a map template commonly used in a company, a template commonly used in a department, and a map template used by a person may be considered to be distinguished in use.

In other words, the linking (mapping) between the items of the metadata between the formats may not simply defined by combination of the formats before and after the conversion, but sometimes the importance of each item may have to be considered according to the use, the user, or the like.

As a template (map template) of linking between items of the metadata between the formats, the multi-format transcoder 101 provides an automatic map template which is defined in advance by combination of the formats and a user map template which is generated and registered by the user. Therefore, the user may perform the inheritance of the items of the metadata by using the more appropriate template, so that it is possible to more easily and appropriately suppress a decrease in data amount of the metadata due to the mismatching of the items (or item names) at the time of the transcoding.

In addition, the multi-format transcoder 101 provides a GUI for generating and registering such a user map template. Therefore, the user may more easily generate and register the user map template.

### [Configurations of Devices]

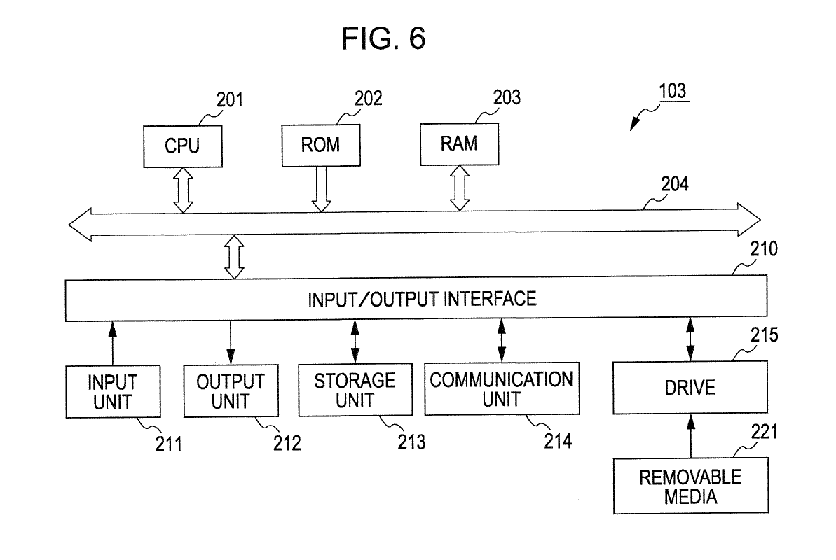

Now, configurations of devices constituting the conversion system 100 are described. FIG. 6 is a block diagram illustrating an example of a main hardware configuration of the remote client 103 of FIG. 1.

In FIG. 6, a CPU (Central Processing Unit) 201 of the remote client 103 executes various processes according to a program stored in a ROM (Read Only Memory) 202 or a program loaded on a RAM (Random Access Memory) 203 from a storage unit 213. The RAM 203 also appropriately stores data or the like necessary for execution of various processes by the CPU 201.

The CPU 201, the ROM 202, and the RAM 203 are connected to each other via a bus 204. An input/output interface 210 is also connected to the bus 204.

An input unit 211 constructed with a keyboard, a mouse, or the like, a display constructed with a CRT (Cathode Ray Tube), an LCD (Liquid Crystal Display), or the like, an output unit 212 constructed with a speaker or the like, a storage unit 213 constructed with a hard disk, a SSD (Solid State Drive), or the like, and a communication unit 214 constructed with a modem, a wired LAN (Local Area Network) interface, a wireless LAN interface, or the like are connected to the input/output interface 210. The communication unit 214 performs a communication process through the network 102, for example, the Internet, or the like.

In addition, a drive 215 is connected to the input/output interface 210 if necessary, and a removable media 221 such as a magnetic disk, an optical disk, opto-magnetic disk, or a semiconductor memory is appropriately mounted thereon, so that a computer program or data read therefrom is installed in the storage unit 213, if necessary.

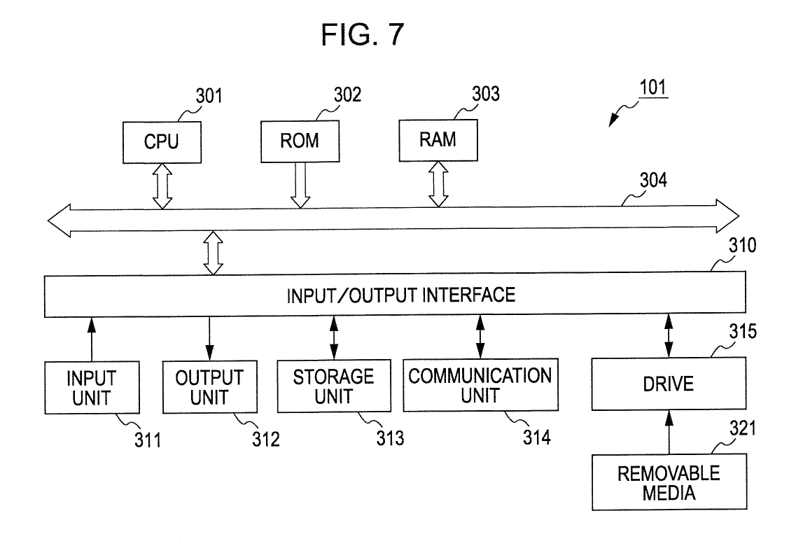

FIG. 7 is a block diagram illustrating an example of a main hardware configuration of the multi-format transcoder 101 of FIG. 1.

As illustrated in FIG. 7, the multi-format transcoder 101 basically has the same configuration as that of the remote client 103 of FIG. 6. In other words, the multi-format transcoder 101 includes a CPU 301 corresponding to the CPU 201, a ROM 302 corresponding to the ROM 202, a RAM 303 corresponding to the RAM 203, and a bus 304 corresponding to the bus 204. In addition, the multi-format transcoder 101 includes an input/output interface 310 corresponding to the input/output interface 210, an input unit 311 corresponding to the input unit 211, an output unit 312 corresponding to the output unit 212, a storage unit 313 corresponding to the storage unit 213, a communication unit 314 corresponding to the communication unit 214, and a drive 315 corresponding to the drive 215. A removable media 321 corresponding to the removable media 221 is mounted on the drive 315.

The remote client 103 and the multi-format transcoder 101 may have configurations in addition to the aforementioned configurations.

### [Function Blocks of Conversion System]

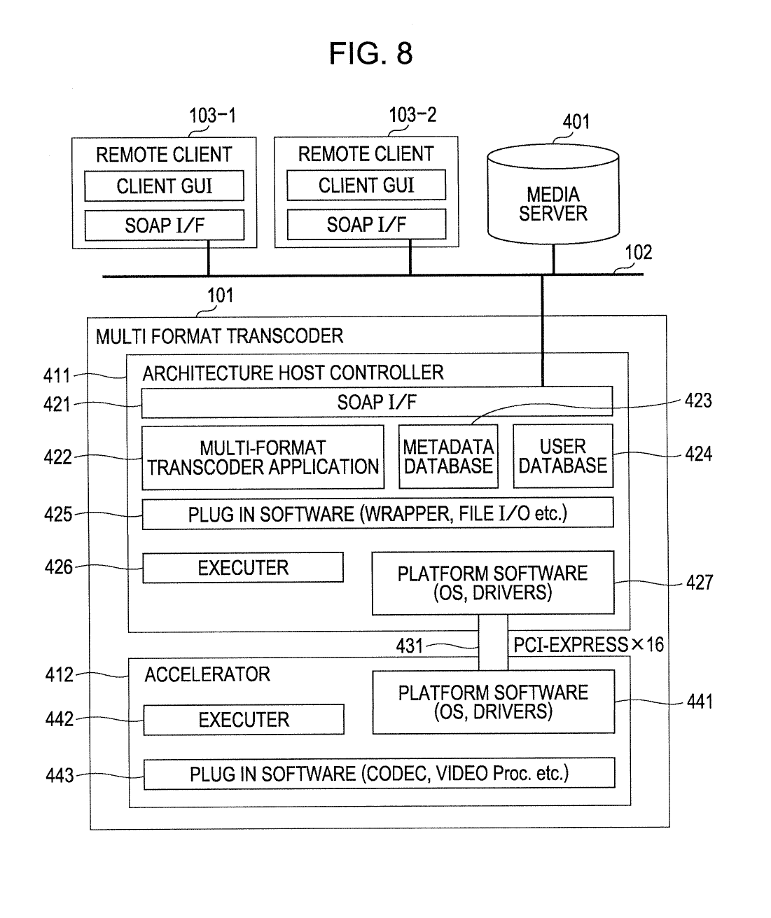

Now, functions of the devices are described. FIG. 8 is a function block diagram illustrating functions of the devices.

As illustrated in FIG. 8, each of the remote clients 103 includes a client GUI (Client GUI) which is a function of displaying a GUI for allowing a user to control the multi-format transcoder 101 and a SOAP interface (SOAP i/f) which is a function of communication with the multi-format transcoder 101.

The multi-format transcoder 101 includes an architecture host controller 411 which controls the conversion process and an accelerator 412 which is controlled by the architecture host controller 411 to actually perform the conversion process.

The architecture host controller 411 includes an SOAP interface (SOAP i/f) 421 which is a function which performs communication with the remote client 103 via the network 102. In addition, the architecture host controller 411 includes a multi-format transcoder application 422 which implements various functions as a multi-format transcoder 10.

In addition, the architecture host controller 411 includes a metadata database 423 which manages a metadata of each file and a user database 424 which manages information on transcoding.

In addition, the architecture host controller 411 includes plug-in software 425 for wrapper, file input and output (File I/O), or the like executed in associated with execution of an application.

In addition, the architecture host controller 411 includes an execution unit 426 which executes various processes according to an application or the like.

In addition, the architecture host controller 411 includes platform software 427 which operates OS, drivers, or the like.

The platform software 427 of the architecture host controller 411 operates in cooperation with the platform software 441 of the accelerator 412 via a bus 431 such as a PCI Express ×16.

In addition, the accelerator 412 includes an execution unit 442 which executes the task designated by the architecture host controller 411 and plug-in software 443 for encoding (Codec), a image process (Video Proc), or the like which is appropriately executed in association with the execution of the task.

In other words, the architecture host controller 411 performs communication with the remote client 103 or generation, management, or the like on the transcoding or the other processes, and the accelerator 412 executes the task generated by the architecture host controller 411. In addition, the architecture host controller 411 performs generation or management of information on the transcoding.

In addition, the architecture host controller 411 and the accelerator 412 may be implemented by physically different CPUs, may be implemented in different cores or threads of one CPU, or may be implemented by time division of one core.

In addition, as illustrated in FIG. 8, the media server 401 which stores files of clips is also connected to the network 102. In other words, the multi-format transcoder 101 stores and manages addresses of locations of the files, some or all of the metadata, or the like. However, in terms of cost reduction or the like, the multi-format transcoder 101 may not store (manage) the files. In addition, the files may be stored in the architecture host controller 411.

### [User Map Template Generation]

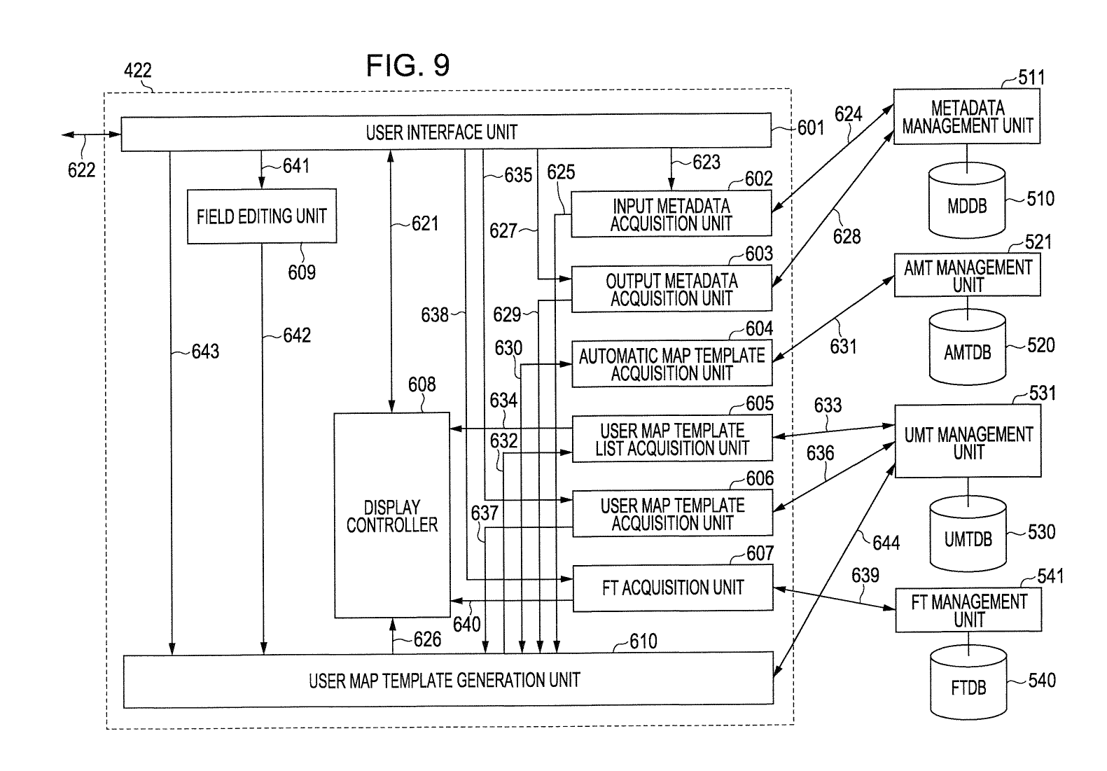

Now, user map template generation is described. FIG. 9 is a diagram illustrating an example of main function blocks associated with the user map template generation.

As illustrated in FIG. 9, as the metadata database 423 of FIG. 8, an MDDB 510 and a metadata management unit 511 are formed. The MDDB 510 is a database which stores and manages the metadata of the clips. In addition, the MDDB 510 also stores and manages a list (metadata table) of items included in the metadata having arbitrary formats.

The metadata table is a list of items (item names) of the metadata, which are defined according to the formats. A value of each item is null. A metadata of a specific clip is a data which sets appropriate values of the items of the metadata table. In other words, a metadata of a clip includes item names and values.

The MDDB 510 stores and manages both of the item names and values. The metadata management unit 511 manages the input and output of the MDDB 510.

In addition, as illustrated in FIG. 9, as the user database 424 of FIG. 8, an AMTDB 520, an AMT management unit 521, an UMTDB 530, an UMT management unit 531, an FTDB 540, and an FT management unit 541 are formed.

The AMTDB 520 is a database which stores and manages an automatic map template (AMT) which is a template which performs linking (mapping) each item of a metadata to a pattern, which is defined in advance, between predetermined formats. The AMT management unit 521 manages the input and output of the AMTDB 520.

The UMTDB 530 is a database which stores and manages a user map template (UMT) which is a template which performs linking (mapping) each item of a metadata to a pattern, which is defined by a user, between predetermined formats. The UMT management unit 531 manages the input and output of the UMTDB 530.

The FTDB 540 is a database of FT information which is information of a family tree (FT) representing a conversion structure of transcoding. The FT management unit 541 manages the input and output of the FTDB 540.

In addition, the function blocks illustrated in the multi-format transcoder application 422 of FIG. 9 are implemented by execution of the multi-format transcoder application 422.

As illustrated in FIG. 9, the multi-format transcoder 101 includes, as the function blocks for the user map template generation, a user interface unit 601, an input metadata acquisition unit 602, an output metadata acquisition unit 603, an automatic map template acquisition unit 604, a user map template list acquisition unit 605, a user map template acquisition unit 606, a FT acquisition unit 607, a display controller 608, a field editing unit 609, and a user map template generation unit 610.

The user interface unit 601 performs receiving the information from the remote client 103 through the SOAP interface 421 to receive instructions from the user to supply various kinds of information.

The input metadata acquisition unit 602 to the user map template generation unit 610 performs various processes based on the instructions or requests supplied through the user interface unit 601.

The user map template generation is instructed, the display controller 608, as indicated by the arrow 621 and the arrow 622, instructs the remote client 103 to perform displaying the GUI (Graphical User Interface) image for generating the user map through the user interface unit 601.

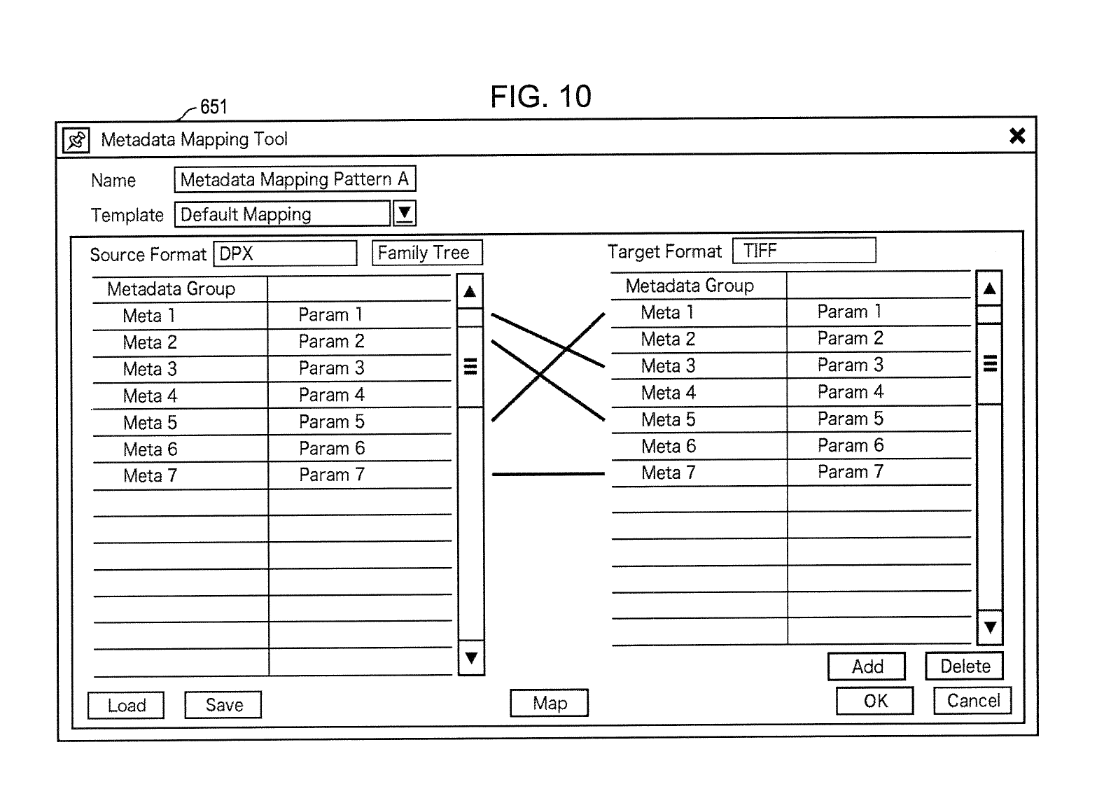

According to the instruction, the remote client 103 displays the GUI for the metadata mapping, as illustrated in, for example, FIG. 10.

The image 651 illustrated in FIG. 10 is a GUI image on which the linking (metadata mapping) of each item of the metadata is performed between the formats for generating the user map template used for the metadata conversion at the time of the format transcoding.

A list of the items (and the values) of the metadata of the input format, which is a format before the conversion in the transcode, is displayed on the left side of the image 651, and a list of the items (and the values) of the metadata of the output format, which is a format after the conversion in the transcoding is displayed on the right side thereof.

In addition, in the image 651, the user may designate the to-be-used user map template to display each item, to perform the linking or editing each of the items displayed on the left and right sides, or to store the current linking pattern as a new user map template.

Returning to FIG. 9, if the designation of the format of the input side and the metadata performed based on the GUI image is received as indicated by the arrow 623, the input metadata acquisition unit 602 accesses the metadata management unit 511 as indicated by the bi-directional arrow 624 to acquire a metadata table or a metadata having a designated format from the MDDB 510. As indicated by the arrow 625, the input metadata acquisition unit 602 supplies the acquired metadata table or metadata to the user map template generation unit 610.

As indicated by the arrow 626, the user map template generation unit 610 supplies the information of each item (in the case of the metadata table, including item names and in the case of the metadata, further including values) of the supplied metadata table or metadata to the display controller 608. The display controller 608 allows the information to be supplied to the remote client 103 and to be reflected on the GUI image. In other words, in the left side column of the image 651 of FIG. 10, the list of the item names of the metadata of the format designated by the user is displayed (in the case where the metadata is designated, the list of the item names and the values is displayed). Therefore, the user may easily refer to the item names (and the values in the case where the metadata is designated) simply by designating the input format (or the metadata).

Similarly, if the designation of the format of the output side performed based on the GUI image is received as indicated by the arrow 627, the output metadata acquisition unit 603 accesses metadata management unit 511 as indicated by the bi-directional arrow 628 in order to acquire a metadata table having a designated format from the MDDB 510. As indicated by the arrow 629, the output metadata acquisition unit 603 supplies the acquired metadata table to the user map template generation unit 610.

Similarly to the case of the input side, the information is supplied to the remote client 103 and is reflected on the GUI image. In other words, in the right side column of the image 651 of FIG. 10, the list of the item names of the metadata of the format designated by the user is displayed. Therefore, the user may easily refer to the item names simply by designating the output format.

In this manner, if both of the input format and the output format (input and output formats) are designated, the user map template generation unit 610, as indicated by the bi-directional arrow 630, notifies the input and output formats to the automatic map template acquisition unit 604. As indicated by the bi-directional arrow 631, the automatic map template acquisition unit 604 accesses the AMT management unit 521 to acquire the automatic map template (AMT) between the designed two formats from the AMTDB 520. As indicated by the bi-directional arrow 630, the automatic map template acquisition unit 604 supplies the acquired automatic map template to the user map template generation unit 610. In other words, in this case, the user map template generation unit 610 generates a new user map template by using the automatic map template of which the conversion pattern is defined in advance.

Similarly to the case of the input and output formats, the information is supplied to the remote client 103 and is reflected on the GUI image. In other words, lines connecting the left and right items are displayed between the left and right columns in the image 651 of FIG. 10. These lines represent relationships between the items which are linked with the automatic map template. Therefore, the user may easily perform the linking (mapping) of the items simply by designating the input and output formats.

In addition, if both of the input format and the output format (input and output formats) are designated, the user map template generation unit 610, as indicated by the bi-directional arrow 632, notifies the input and output formats to the user map template list acquisition unit 605. As indicated by the arrow 633, the user map template list acquisition unit 605 accesses the UMT management unit 531 to acquire the user map template (UMT) list between the designated two formats from the UMTDB 530. As indicated by the arrow 634, the user map template list acquisition unit 605 supplies the acquired user map template list to the display controller 608.

The display controller 608 allows the information to be supplied to the remote client 103 through the user interface unit 601 and to be reflected on the GUI image. In other words, the list of the user map templates is reflected in the selectable list of the user map template name designation column (Template) of the image 651 of FIG. 10. Therefore, the user may easily select a desired user map template among the user map template corresponding to the designated input and output formats. In other words, the user may easily designate an appropriate user map template corresponding to the designated input and output formats.

If the user designates the user map template in the user map template name designation column (Template) in the image 651 of FIG. 10, the designation information is supplied from the remote client 103 to the multi-format transcoder 101.

The designation information is received through the user interface unit 601 as indicated by the arrow 635, the user map template acquisition unit 606, as indicated by the bi-directional arrow 636, accesses the UMT management unit 531 to acquire the designated user map template (UMT) from the UMTDB 530. As indicated by the arrow 637, the user map template acquisition unit 606 supplies the acquired user map template to the user map template generation unit 610. In other words, in this case, the user map template generation unit 610 generates a new user map template by reusing the existing user map template.

Similarly to the automatic map template, the information is supplied to the remote client 103 and is reflected on the GUI image. In other words, lines connecting the left and right items are displayed between the left and right columns in the image 651 of FIG. 10.

In addition, the linking by the user map template has priority over the linking by the automatic map template. For example, in the case where the linking by the user map template has priority over the linking by the automatic map template, the linking by the user map template is added, and the linking by the automatic map template is removed or changed, if necessary. In addition, after the linking by the automatic map template is entirely removed, the linking by the user map template may be applied.

Accordingly, simply by selecting the user map template, the user allows the linking by the user map template to be easily reflected on the linking of the items of the metadata between the input and output formats.

Instead of designation of the input format, the user may designate a metadata (input metadata) of a specific clip. A family tree (FT) representing a conversion structure of a transcode may be used for the designation of the input metadata.

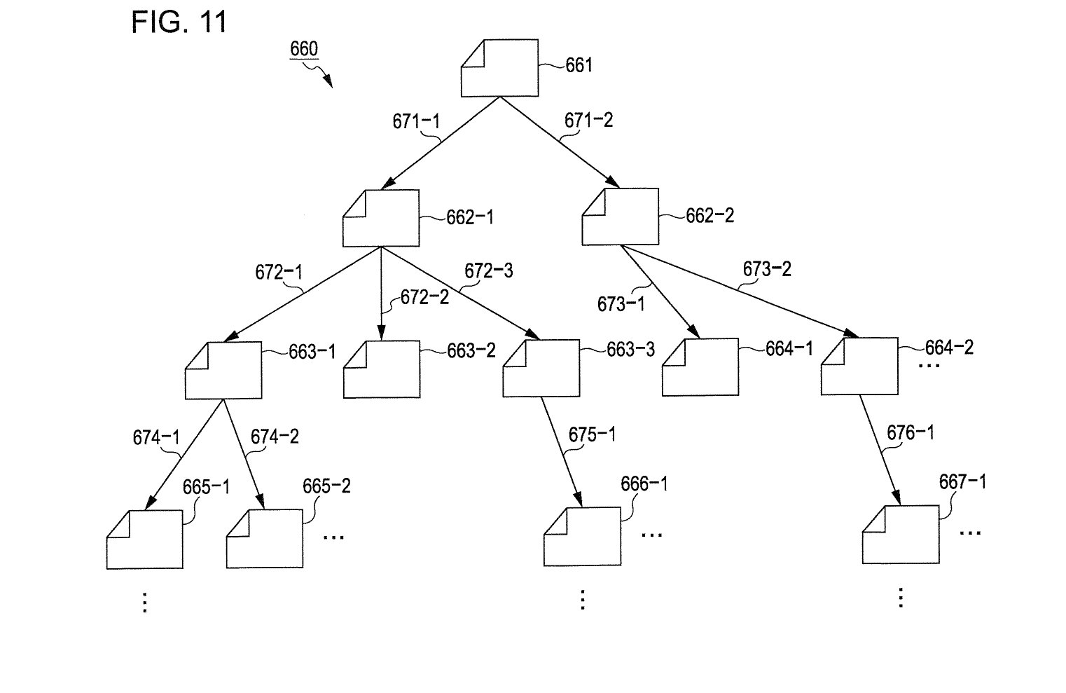

FIG. 11 is a diagram illustrating an example of a format conversion structure.

In FIG. 11, the conversion structure 660 represents a conversion structure of transcode in which the clip 661 is set as an original (ancestor). As illustrated in FIG. 11, in the conversion structure 660, the clip 661 is transcoded as indicated by the arrow 671-1, so that the clip 662-1 is generated. Similarly, the clip 661 is transcoded as indicated by the arrow 671-2, so that the clip 662-2 is generated.

Hereinafter, similarly, the clip 662-1 is transcoded (the arrow 672-1 to the arrow 672-3), so that the clips 663-1 to clip 663-3 are generated; and the clip 662-2 is transcoded (the arrow 673-1 and the arrow 673-2), so that the clip 674-1 and the clip 674-2 are generated.

In addition, similarly, the clip 663-1 is transcoded (the arrow 674-1 and the arrow 674-2), so that the clip 665-1 and the clip 665-2 are generated; the clip 663-3 is transcoded (the arrow 675-1), so that the clip 666-1 is generated; and the clip 664-2 is transcoded (the arrow 676-1), so that the clip 667-1 is generated.

In this manner, one clip may be transcoded to a plurality of formats. In addition, the clip after the conversion may be further transcoded. By the transcode, as illustrated in FIG. 11, one conversion structure 660 in which one clip is set as an original (ancestor) is formed.

The multi-format transcoder 101 allows the FTDB 540 to manage the family tree (FT) representing the conversion structure 660 so as to easily recognize the relationship between the clips, the formats of the clips, or the like.

The transcoding performed by the multi-format transcoder 101 is performed on the clip in the conversion structure 660. Therefore, when a metadata of a specific clip is to be designated, the clip is designated by using the family tree (FT). Accordingly, the user may also refer to a relationship with respect to the other clips, so that the designation of the clip may be more easily performed.

If the family tree button (Family Tree) is manipulated in the image 651 of FIG. 10, the family tree display request is supplied from the remote client 103 to the multi-format transcoder 101.

If the request is received through the user interface unit 601 as indicated by the arrow 638, the FT acquisition unit 607, as indicated by the bi-directional arrow 639, accesses the FT management unit 541 to acquire the FT information, that is, the family tree information from the FTDB 540. As indicated by the arrow 640, the FT acquisition unit 607 supplies the acquired FT information to the display controller 608.

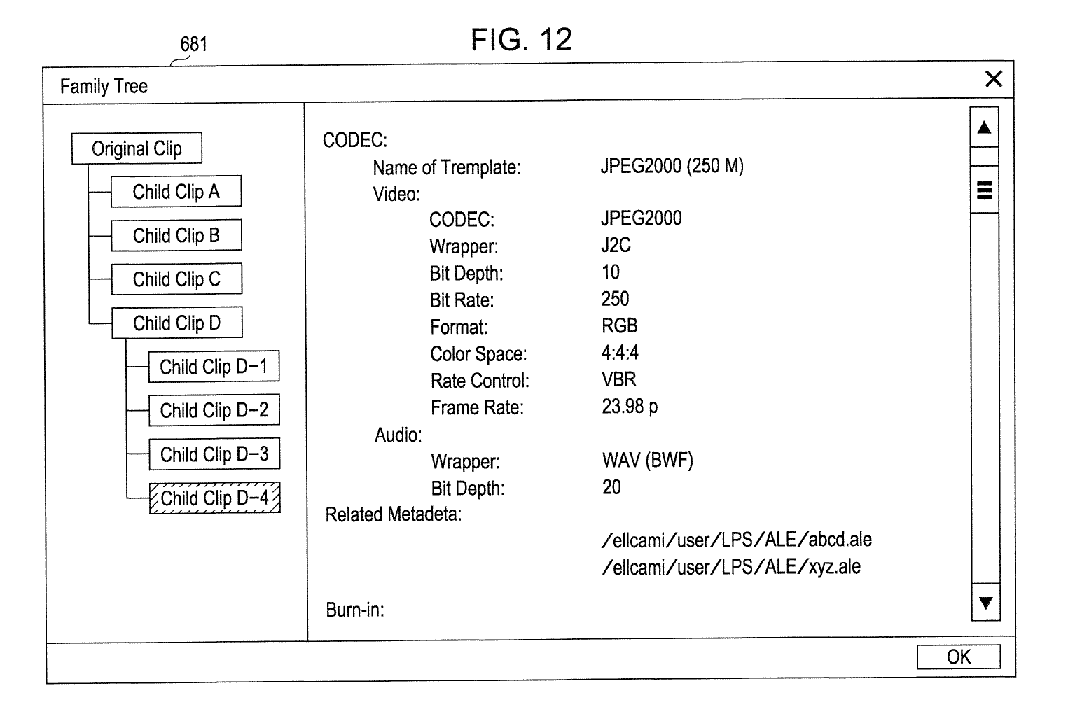

Similarly to the case of the user map template list, the information is supplied to the remote client 103. The remote client 103 displays the GUI image, on which the family tree (FT) is displayed, for example, the image 681 of FIG. 12 on a monitor.

With respect to the image 681 of FIG. 12, the area may be divided into left and right side areas, and the family tree representing the conversion structure is displayed in the left side area.

In the case of an example of FIG. 12, in the family tree illustrated on the image 681, an a clip (original clip) of an original (ancestor) is transcoded four times, so that four child clips (Child Clip A, Child Clip B, Child Clip C, and Child Clip D) are generated, and the child clip D is transcoded four times, so that the four child clips (Child Clip D-1, Child Clip D-2, Child Clip D-3, and Child Clip D-4) are generated.

In this manner, in the family tree (FT), the relationship between the clips before and after the conversion (relationship between parents and children) is represented by lines. Therefore, the user may easily recognize the configuration of the conversion structure. In addition, for example, a clip in which a file is removed may be represented by changing a color or a concentration of a node of the family tree. Therefore, the user may easily recognize whether or not a desired file of the clip exists.

The method of expressing the FT is arbitrary.

If several nodes (clips) are designated and selected in the family tree of the image 681, the metadata of the clips are designated as the input metadata, and the designation information is supplied from the remote client 103 to the multi-format transcoder 101. As described above, the designation information is processed by the input metadata acquisition unit 602 or the like.

In addition, the user may edit (add, remove, or update) the information (items or values) of the items of the input and output formats in the image 651 of FIG. 10. If the user instructs the field editing, the instruction is supplied from the remote client 103 to the multi-format transcoder 101.

If the field editing unit 609 acquires the editing instruction through the user interface unit 601 as indicated by the arrow 641, the field editing unit 609 edits the information (item names or values) of the items (fields) of the metadata of the input and output formats, which are stored in the user map template generation unit 610, according to the editing instruction as indicated by the arrow 642.

The result of the editing is supplied to the remote client 103 and is reflected on the GUI image. In other words, the items of the left and right columns in the image 651 of FIG. 10 are edited. In this manner, the user may easily edit the items of the metadata of the input and output formats.

In addition, the user may edit (add, remove, or update) the linking (mapping) of the items of the input and output formats in the image 651 of FIG. 10. If the user instructs the map editing, the instruction is supplied from the remote client 103 to the multi-format transcoder 101.

If the user map template generation unit 610 acquires the map editing instruction through the user interface unit 601 as indicated by the arrow 643, the user map template generation unit 610 edits the linking (mapping) of the items between the input and output formats according to the map editing instruction.

The result of the editing is supplied to the remote client 103 and is reflected on the GUI image. In other words, the lines between the left and right columns in the image 651 of FIG. 10 are edited. In this manner, the user may easily edit the linking of the items of the metadata between the input and output formats.

In addition, the user may record the current state of the linking (mapping) of the items of the input and output formats in the image 651 of FIG. 10 as a new user map template. If the user instructs the generation of user map template, the instruction is supplied from the remote client 103 to the multi-format transcoder 101.

If the user map template generation unit 610 acquires the generation instruction through the user interface unit 601 as indicated by the arrow 643, the user map template generation unit 610, as indicated by the bi-directional arrow 644, allows the current state of the linking (mapping) of the items of the input and output formats to be supplied to the UMT management unit 531 and to be stored and managed in the UMTDB 530 as a new user map template according to the generation instruction. In addition, in the case where the user map template having the same name already exists, the user map template may be overwritten and updated.

Accordingly, the user may easily generate and store the user map template.

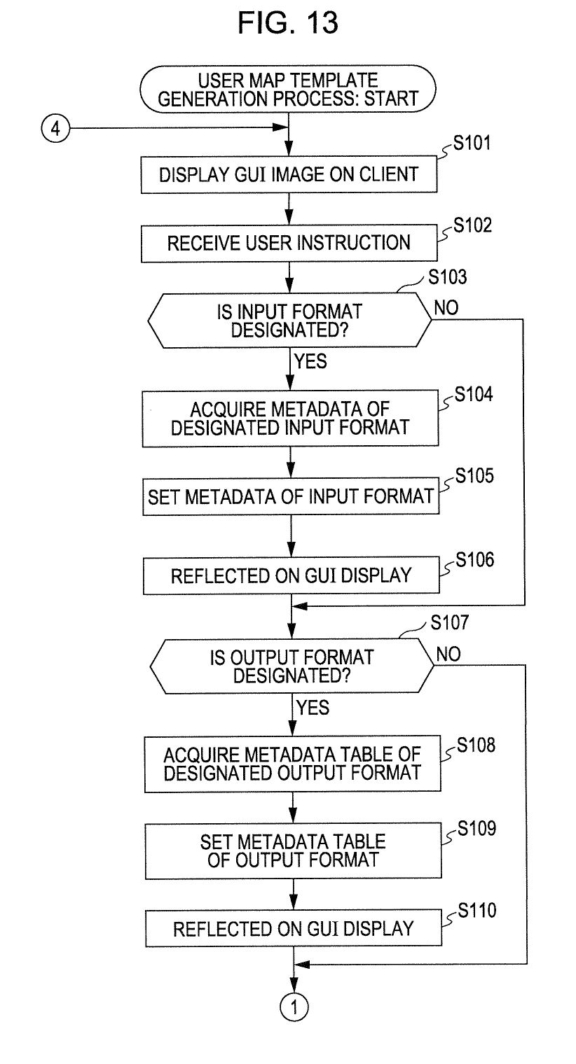

An example of a flow of the user map template generation process is described with reference to flowcharts of FIGS. 13 to 16.

If the user interface unit 601 acquires the user map template generation instruction from the remote client 103, the user map template generation process starts. If the user map template generation process starts, in Step S101, the display controller 608 displays, for example, the GUI image such as an image 651 illustrated in FIG. 10 on the remote client 103 as a requesting site. In Step S102, the user interface unit 601 receives the user instruction supplied from the remote client 103.

In Step S103, the user interface unit 601 determines whether or not the input format is designated. In the case where the input format is determined to be designated, the procedure proceeds to Step S104.

In Step S104, the input metadata acquisition unit 602 acquires the metadata table of the designated input format from the MDDB 510. In Step S105, the user map template generation unit 610 sets the metadata table acquired in Step S104 as the metadata table of the input format. In Step S106, the display controller 608 allows the setting to be reflected on the GUI display in the remote client 103.

If the process of Step S106 is ended, the procedure proceeds to Step S107. In addition, in Step S103, in the case where the input format is not determined to be designated, the procedure proceeds to Step S107.

In Step 5107, the user interface unit 601 determines whether or not the output format is designated. In the case where the output format is determined to be designated, the procedure proceeds to Step S108.

In Step S108, the output metadata acquisition unit 603 acquires the metadata table of the designated output format from the MDDB 510. In Step S109, the user map template generation unit 610 sets the metadata table acquired in Step S108 as the metadata table of the output format. In Step S110, the display controller 608 allows the setting to be reflected on the GUI display of the remote client 103.

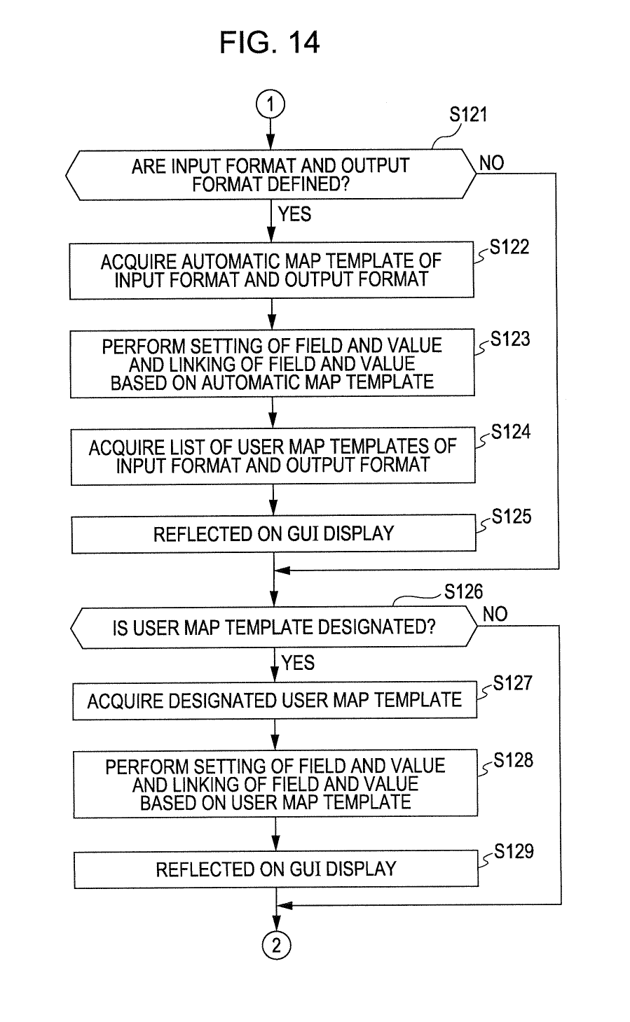

If the process of Step 5110 is ended, the procedure proceeds to Step S121 of FIG. 14. In addition, in Step 5107 of FIG. 13, in the case where the output format is not determined to be designated, the procedure proceeds to Step S121 of FIG. 14.

In Step 5121 of FIG. 14, the user interface unit 601 determines whether or not the input format and the output format are defined. In the case where the input format and the output format are determined to be defined, the procedure proceeds to Step S122.

In Step S122, the automatic map template acquisition unit 604 acquires the automatic map template corresponding to a combination of the input format and the output format from the AMTDB 520. In Step S123, the user map template generation unit 610 performs the setting of the field and the value or the linking of the field and the value based on the automatic map template acquired in Step S122. In Step S124, the user map template list acquisition unit 605 acquires the user map template list corresponding to the combination between the input format and the output format from the UMTDB 531. In Step S125, the display controller 608 allows the setting or linking of the field and the value of the automatic map template or the list of the user map template to be reflected on the GUI display in the remote client 103.

If the process of Step S125 is ended, the procedure proceeds to Step S126. In addition, in Step S121, in the case where at least any one of the input format and the output format is not determined to be defined, the procedure proceeds to Step S126.

In Step S126, the user interface unit 601 determines whether or not the user map template is designated. In the case where the user map template is determined to be designated, the procedure proceeds to Step S127.

In Step S127, the user map template acquisition unit 606 acquires the designated user map template from the UMTDB 530. In Step S128, the user map template generation unit 610 performs the setting of the field and the value or the linking of the field and the value based on the user map template. In Step S129, the display controller 608 allows the setting or linking of the field and the value of the user map template to be reflected on the GUI display in the remote client 103.

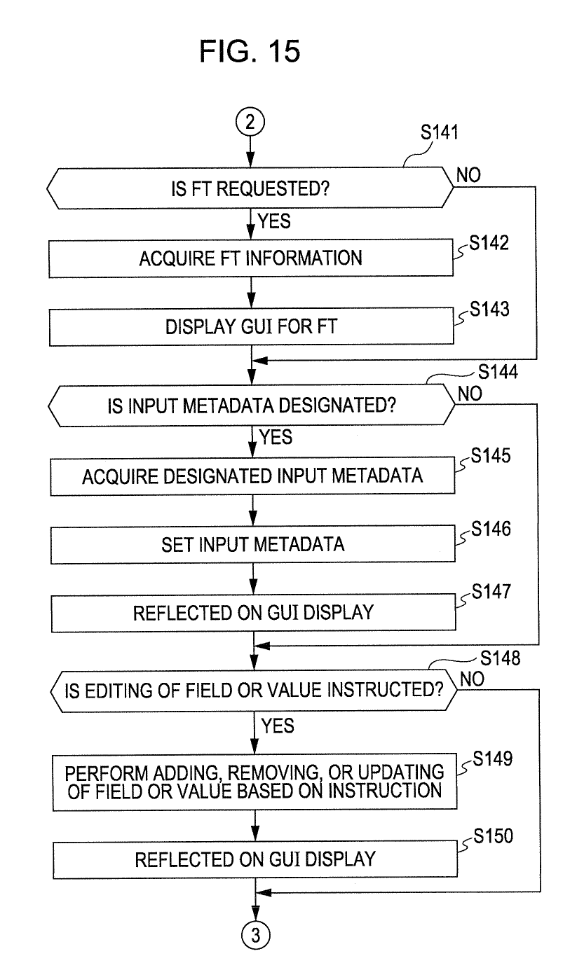

If the process of Step S129 is ended, the procedure proceeds to Step S141 of FIG. 15. In addition, in Step S126 of FIG. 14, in the case where the user map template is not determined to be designated, the procedure proceeds to Step S141 of FIG. 15.

In Step S141 of FIG. 15, the user interface unit 601 determines whether or not the display of the family tree (FT) is necessary. In the case where the family tree (FT) is determined to be necessary, the procedure proceeds to Step S142.

In Step S142, the FT acquisition unit 607 acquires the FT information representing the family tree (FT). In Step S143, the display controller 608 supplies the FT information acquired in Step S142 to the remote client 103 as a requesting site and allows the GUI for family tree (FT) display to be displayed.

If the process of Step S143 is ended, the procedure proceeds to Step S144. In addition, in Step S141, in the case where the display of the family tree (FT) is not determined to be necessary, the procedure proceeds to Step S144.

In Step S144, the user interface unit 601 determines whether or not the input metadata is designated. In the case where the input metadata is determined to be designated, the procedure proceeds to Step S145.

In Step S145, the input metadata acquisition unit 602 acquires the designated input metadata from the MDDB 510. In Step S146, the user map template generation unit 610 sets the input metadata acquired in Step S145. In Step S147, the display controller 608 allows the setting to be reflected on the GUI display in the remote client 103.

If the process of Step S147 is ended, the procedure proceeds to Step S148. In addition, in Step S144, in the case where the input metadata is not determined to be designated, the procedure proceeds to Step S148.

In Step S148, the user interface unit 601 determines whether or not the editing of fields or values is instructed. In the case where the editing of fields or values is determined to be instructed, the procedure proceeds to Step S149.

In Step S149, the field editing unit 609 performs the adding, removing, or updating of the field or value based on the instruction. In Step S150, the display controller 608 allows the editing to be reflected on the GUI display in the remote client 103.

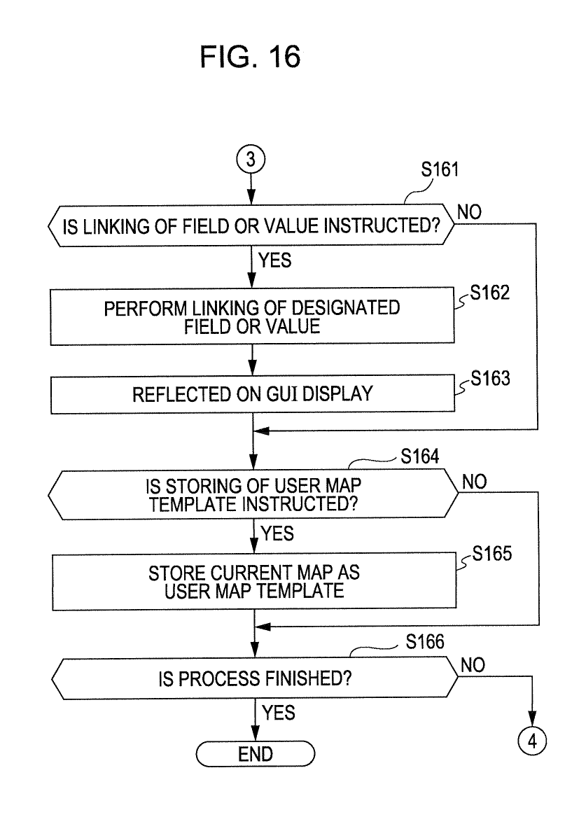

If the process of Step 5150 is ended, the procedure proceeds to Step 5161 of FIG. 16. In addition, in Step S148 of FIG. 15, in the case where the editing of the fields or the values is not determined to be instructed, the procedure proceeds to Step S161 of FIG. 16.

In Step S161 of FIG. 16, the user interface unit 601 determines whether or not the linking of the field or the value is instructed. In the case where the linking of the field or the value is determined to be instructed, the procedure proceeds to Step S162.

In Step S162, the user map template generation unit 610 executes the linking of the field or the value based on the instruction. In Step S163, the display controller 608 allows the linking to be reflected on the GUI display in the remote client 103.

If the process of Step S163 is ended, the procedure proceeds to Step S164. In addition, in Step S161, in the case where the linking of the field or the value is not determined to be instructed, the procedure proceeds to Step S164.

In Step S164, the user interface unit 601 determines whether or not the storing of the user map template is instructed. In the case where the storing of the user map template is determined to be instructed, the procedure proceeds to Step S165.

In Step S165, the user map template generation unit 610 stores the current map as a user map template in the UMTDB 530.

If the process of Step S165 is ended, the procedure proceeds to Step S166. In addition, in Step S164, in the case where the storing of the user map template is not determined to be instructed, the procedure proceeds to Step S166.

In Step S166, the user interface unit 601 determines whether or not the user map template generation process is instructed. In the case where the user map template generation process is determined to be instructed, the user map template generation process is ended. In addition, in Step S166, in the case where the user map template generation process is not determined to be instructed, the procedure returns to Step S101 of FIG. 13, and the subsequent processes repeat.

In this manner, the multi-format transcoder 101 performs the above processes, so that the user may easily generate the user map template.

### [Use of User Map Template]

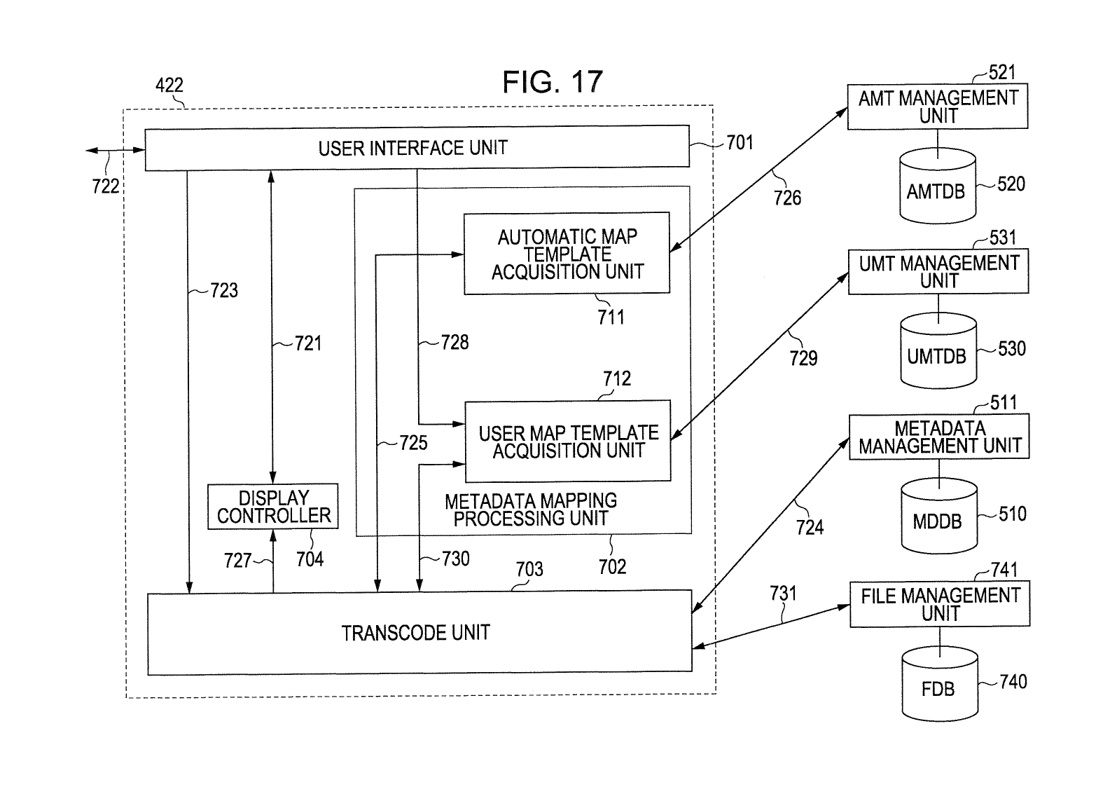

Now, the use of the user map template is described. In the transcoding of the multi-format transcoder 101, when the metadata of the clip is to be converted, the user may use the user map template. FIG. 17 is a diagram illustrating an example of main function blocks associated with the use of the user map template.

As illustrated in FIG. 17, as the media server 401 of FIG. 8, the FDB 740 and the file management unit 741 are formed. The FDB 740 is a database which stores and manages files of each clip.

In addition, the function blocks illustrated in multi-format transcoder application 422 of FIG. 17 are implemented by execution of the multi-format transcoder application 422.

As illustrated in FIG. 17, the multi-format transcoder 101 includes, as the function blocks associated with the use of the user map template, a user interface unit 701, a metadata mapping processing unit 702, a transcode unit 703, and a display controller 704.

The metadata mapping processing unit 702 includes an automatic map template acquisition unit 711 and the user map template acquisition unit 712.

The user interface unit 701 performs receiving the information from the remote client 103 through the SOAP interface 421 to receive instructions from the user or to supply various kinds of information.

The metadata mapping processing unit 702 to the display controller 704 perform various processes based on the instructions or requests supplied through the user interface unit 701.

If the transcoding is instructed, the display controller 704, as indicated by the arrow 721 and the arrow 722, instructs the remote client 103 to perform displaying the GUI image for setting the transcoding through the user interface unit 701.

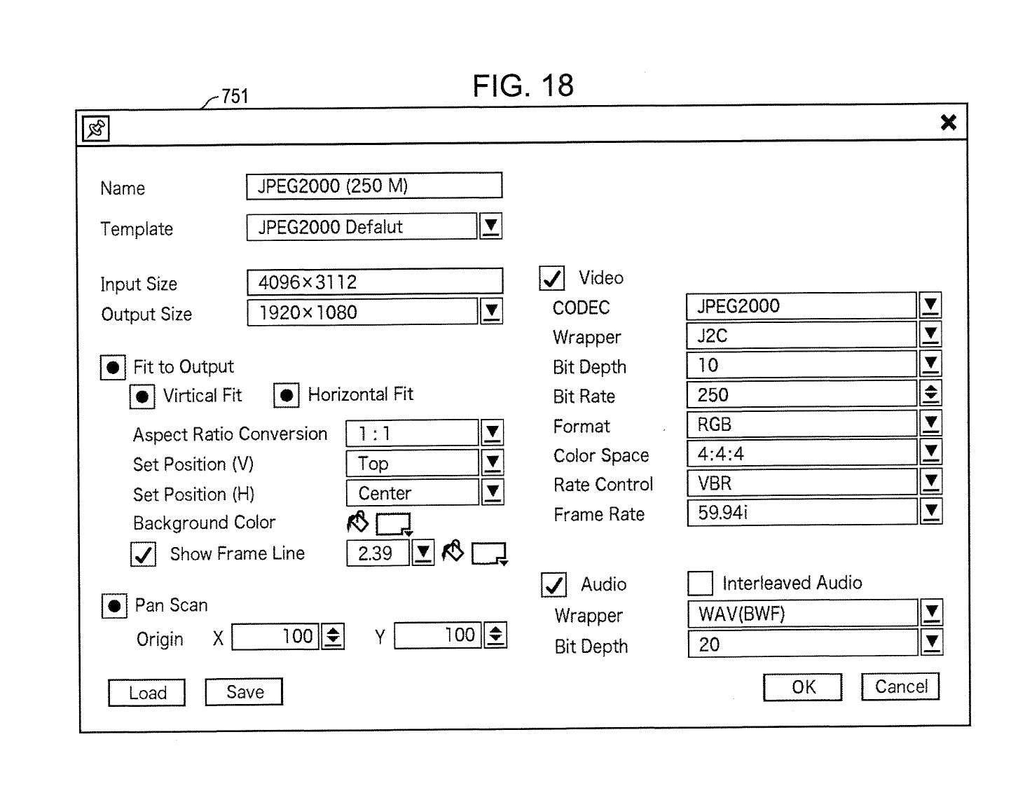

According to the instruction, the remote client 103 displays the GUI for setting the transcode, as illustrated in, for example, FIG. 18.

The image 751 illustrated in FIG. 18 is a GUI image on which the user performs setting the format transcoding. The each portion of the image 751 is manipulated, so that the user performs the setting of the transcoding with respect to the input clip or output clip of the transcoding.

In addition, the user also performs the setting of the conversion of the metadata with respect to the clip, which is performed at the time of the transcoding. The user allows, for example, the GUI image such as an image 651 illustrated in FIG. 10 and performs the setting based on the GUI image.

Returning to FIG. 17, if the setting of the transcoding performed by remote client 103 in this manner is supplied through the user interface unit 701 as indicated by the arrow 723, the transcode unit 703 allows the setting to be reflected in the transcoding process.

As indicated by the bi-directional arrow 724, the transcode unit 703 accesses the metadata management unit 511 to acquire the metadata of the input clip. In addition, as indicated by the bi-directional arrow 725, the transcode unit 703 requests the automatic map template acquisition unit 711 to transmit the automatic map template.

As indicated by the bi-directional arrow 726, the automatic map template acquisition unit 711 accesses the AMT management unit 521 to acquire the automatic map template corresponding to a combination of the input format and the output format designated in the request from the AMTDB 520. As indicated by the bi-directional arrow 725, the automatic map template acquisition unit 711 supplies the acquired automatic map template to the transcode unit 703.

The transcode unit 703 performs the linking of each item of he metadata based on the supplied automatic map template. As indicated by the arrow 727, the transcode unit 703 allows the linking to be supplied to the display controller 704 and to be reflected on the GUI image (for example, an image 651 of FIG. 10) displayed in the remote client 103.

In addition, as indicated by the bi-directional arrow 730, the transcode unit 703 requests the user map template acquisition unit 712 to transmit the user map template. As indicated by the bi-directional arrow 729, the user map template acquisition unit 712 accesses the UMT management unit 531 to acquire the requested user map template from the UMTDB 530.

As indicated by the bi-directional arrow 730, the user map template acquisition unit 712 supplies the user map template to the transcode unit 703. The transcode unit 703 performs the linking of each item of the metadata based on the supplied user map template. As indicated by the arrow 727, the transcode unit 703 allows the linking to be supplied to the display controller 704 and to be reflected on the GUI image (for example, an image 651 of FIG. 10) displayed in the remote client 103.

In addition, the user may designate the user map template by the GUI image such as an image 651, for example, illustrated in FIG. 10 with respect to the remote client 103. If the user designates the user map template, the designation information is supplied from the remote client 103 to the multi-format transcoder 101.

If the designation information is acquired through the user interface unit 701 as indicated by the arrow 728, the user map template acquisition unit 712, as indicated by the bi-directional arrow 729, accesses the UMT management unit 531 to acquire the user map template designated by the designation information from the UMTDB 530.

As indicated by the bi-directional arrow 730, the user map template acquisition unit 712 supplies the user map template to the transcode unit 703. The transcode unit 703 performs the linking of each item of the metadata based on the supplied user map template. As indicated by the arrow 727, the transcode unit 703 allows the linking to be supplied to the display controller 704 and to be reflected on the GUI image (for example, an image 651 of FIG. 10) displayed in the remote client 103.

If the user instructs the remote client 103 to perform transcoding on the GUI image, for example, the image 751 illustrated in FIG. 18, the instruction is supplied from the remote client 103 to the multi-format transcoder 101.

If the instruction is acquired through the user interface unit 701 as indicated by the arrow 723, the transcode unit 703, as indicated by the bi-directional arrow 731, accesses the file management unit 741 to acquire the input clip file from the FDB 740. The transcode unit 703 performs the transcoding of the format with respect to the file acquired from the FDB 740 or the metadata acquired from the MDDB 510.

The transcode unit 703 allows the file of the output clip, which is a result of the transcode, to be stored in the FDB 740 and to be managed and allows the metadata of the output clip to be stored in the MDDB 510 and to be managed. In addition, the transcode unit 703 allows the result of the transcoding to be supplied through the display controller 704 to the remote client 103 and to be displayed.

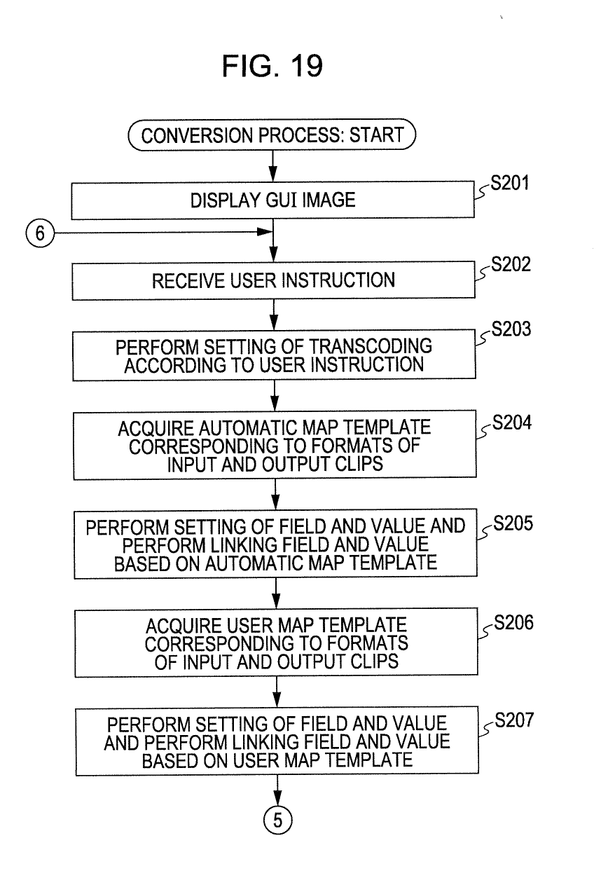

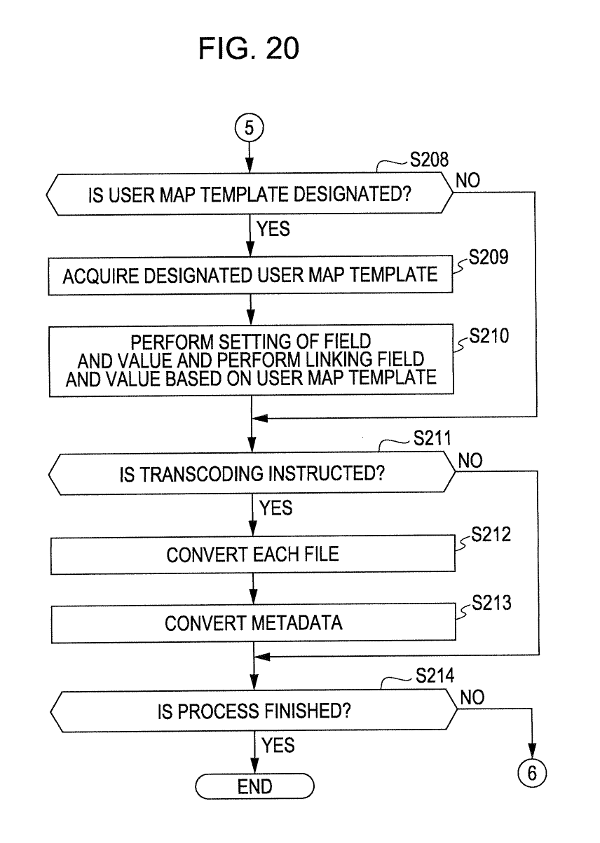

An example of the flow of the conversion process is described with reference to the flowcharts of FIGS. 19 and 20.

If the user instructs the remote client 103 to set the transcode, the instruction is supplied from the remote client 103 to the multi-format transcoder 101. If the instruction is received, the conversion process starts.

If the conversion process starts, in Step S201, the display controller 704 allows the remote client 103 to display the GUI image. In Step S202, the user interface unit 701 receives the user instruction supplied from the remote client 103.

In Step S203, the transcode unit 703 performs the setting of the transcoding according to the received user instruction. In Step S204, the automatic map template acquisition unit 711 acquires the automatic map template corresponding to the format of the input clip or the output clip (input and output clips). In Step S205, the transcode unit 703 performs the setting of the field and the value or the linking of the field and the value of the transcoded metadata based on the automatic map template acquired in Step S204.

In Step S206, the user map template acquisition unit 712 acquires the user map template corresponding to the formats of the input and output clips. In Step S207, the transcode unit 703 performs the setting of the field and the value or the linking of the field and the value of the transcoded metadata based on the user map template acquired in Step S206.

In addition, similarly to the aforementioned user map template generation time, the setting or the linking by the user map template has priority over the setting or the linking by the automatic map template.

If the process of Step S207 is ended, the procedure proceeds to Step S208 of FIG. 20.

In Step S208 of FIG. 20, the user interface unit 701 determines whether or not the user map template is designated by the user. In the case where the user map template is determined to be designated, the procedure proceeds to Step S209.

In Step S209, the user map template acquisition unit 712 acquires the designated user map template from the UMTDB 530. In Step S210, the transcode unit 703 performs the setting of the field and the value or the linking of the field and the value of the transcoded metadata based on the user map template acquired in Step S209.

If the process of Step S210 is ended, the procedure proceeds to Step S211. In addition, in Step S208, in the case where the user map template is not determined to be designated, the procedure proceeds to Step S211.

In Step S211, the user interface unit 701 determines whether or not the execution of the transcoding is instructed by the user. In the case where the execution of the transcoding is determined to be instructed, the procedure proceeds to Step S212.

In Step S212, the transcode unit 703 converts each file. In addition, in Step S213, the transcode unit 703 performs conversion (inheritance) of the metadata. If the process of Step S213 is ended, the procedure proceeds to Step S214. In addition, in Step S211, in the case where the execution of the transcoding is not determined to be instructed, the procedure proceeds to Step S214.

In Step S214, the user interface unit 701 determines whether or not the conversion process is ended. In the case where the ending of the transcoding is not determined to be instructed by the user and the conversion process is not determined to be ended, the procedure returns to Step S202 of FIG. 19, and the subsequent processes repeat. In addition, in the case where the ending of the transcoding is determined to be instructed by the user and, in Step 214 of FIG. 20, the conversion process is determined to be ended, the conversion process is ended.

In this manner, by performing the conversion process, the multi-format transcoder 101 performs the transcoding of the metadata by using the user map template. Therefore, the user may more easily and appropriately execute the transcoding of the metadata.

### [Multi-task Management]

The multi-format transcoder 101 performs each process such as transcoding as a task. The multi-format transcoder 101 may manage the execution of the task and may execute a plurality of the tasks in parallel simultaneously.

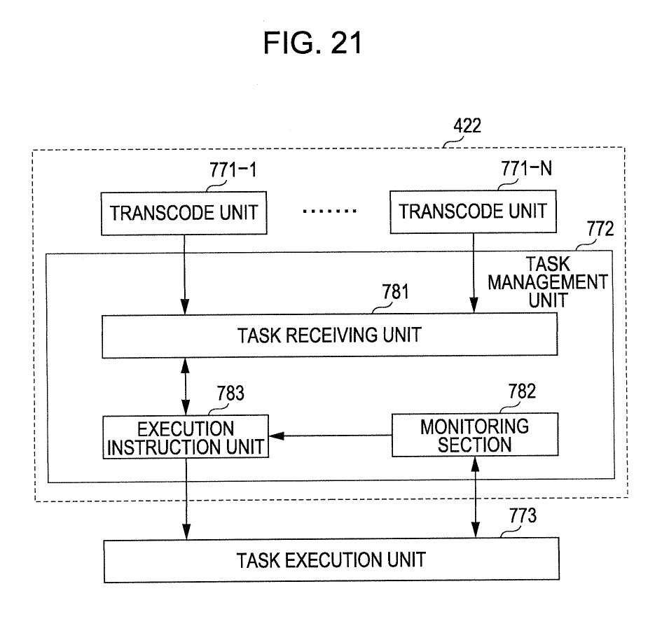

FIG. 21 is a diagram illustrating an example of main function blocks for execution and management of multi-tasks. Each function block illustrated in FIG. 21 is implemented by execution of the multi-format transcoder application 422.

As illustrated in FIG. 21, the multi-format transcoder 101 includes, as function blocks for the execution and management of the multi-tasks, a transcode unit 771-1 to a transcode unit 771-N, a task management unit 772, and a task execution unit 773.

The transcode unit 771-1 to the transcode unit 771-N are N dependent transcode units, each of which is a processing unit basically the same as, for example, the transcode unit 703 of FIG. 17. Each of the transcode unit 771-1 to the transcode unit 771-N issues the transcoding process as a task. Hereinafter, in the case where the transcode unit 771-1 to the transcode unit 771-N may not have to be distinguished in the description, the transcode units are simply referred to as transcode units 771.

The task management unit 772 manages the execution of the task supplied from the transcode unit 771. The task management unit 772 includes a task receiving unit 781, a monitoring unit 782, and an execution instruction unit 783.

The task receiving unit 781 receives the task supplied from the transcode unit 771. The monitoring unit 782 monitors the task execution situation of the task execution unit 773 where the task is executed. In the case where a new task is executable, the task execution unit 773 notifies the fact to the execution instruction unit 783. In the case where permission is received from the monitoring unit 782, the execution instruction unit 783 supplies the task, which is received by the task receiving unit 781, to the task execution unit 773, so that the task is allowed to be executed.

The task execution unit 773 represents, for example, the accelerator 412 of FIG. 8. The task execution unit 773 may simultaneously execute a plurality of the tasks in parallel. The task execution unit 773 executes the task supplied according to the instruction of the execution instruction unit 783.

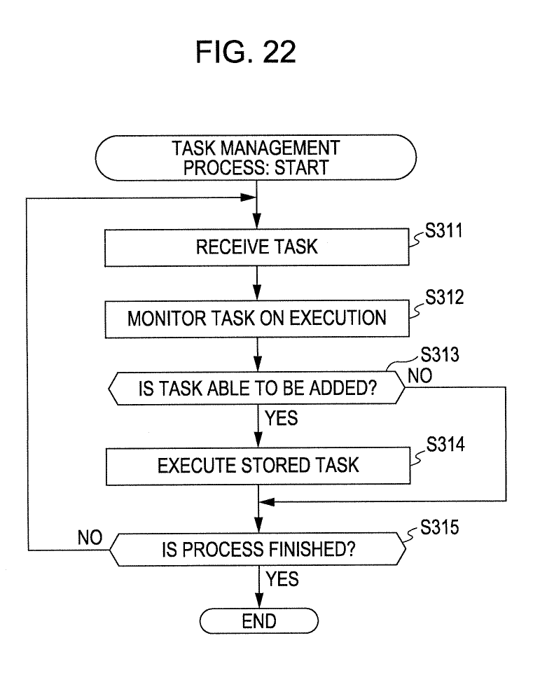

An example of a flow of the task management process which performs management of task execution is described with reference to a flowchart of FIG. 22.

If the task management process starts, in Step S311, the task receiving unit 781 receives a task. In Step S312, the monitoring unit 782 monitors the task which is on execution in the task execution unit 773. In Step S313, the monitoring unit 782 determines whether or not the task is able to be added. In the case where the task is determined to be able to be added, the procedure proceeds to Step S314.

In Step S314, the execution instruction unit 783 allows the stored task to be supplied to the task execution unit 773 and to be executed. If the process of Step S314 is ended, the procedure proceeds to Step S315. In addition, in Step S313, in the case where the task is not determined to be able to be added, the procedure proceeds to Step S315.

In Step S315, the task management unit 772 determines whether or not the task management process is ended. In the case where the task management process is not determined to be ended, the procedure returns to Step S311, and the subsequent processes repeat. In the case where the task management process is determined to be ended, the task management process is ended.

In this manner, since the multi-format transcoder 101 manages the execution of the tasks, it is possible to simultaneously execute multiple tasks in parallel.

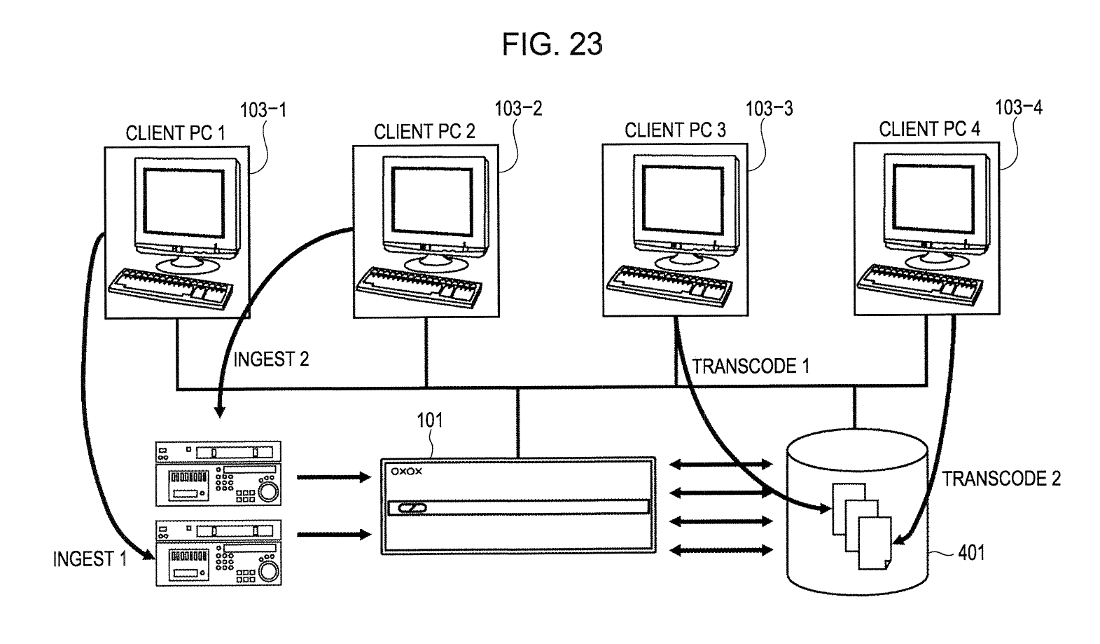

Therefore, for example, as illustrated in FIG. 23, the requests from a plurality of the remote clients 103 are received in parallel, and various processes such as an ingesting process or transcoding may be appropriately scheduled and executed in parallel. Therefore, it is possible to implement a conversion system 100 capable of efficiently executing the processes.

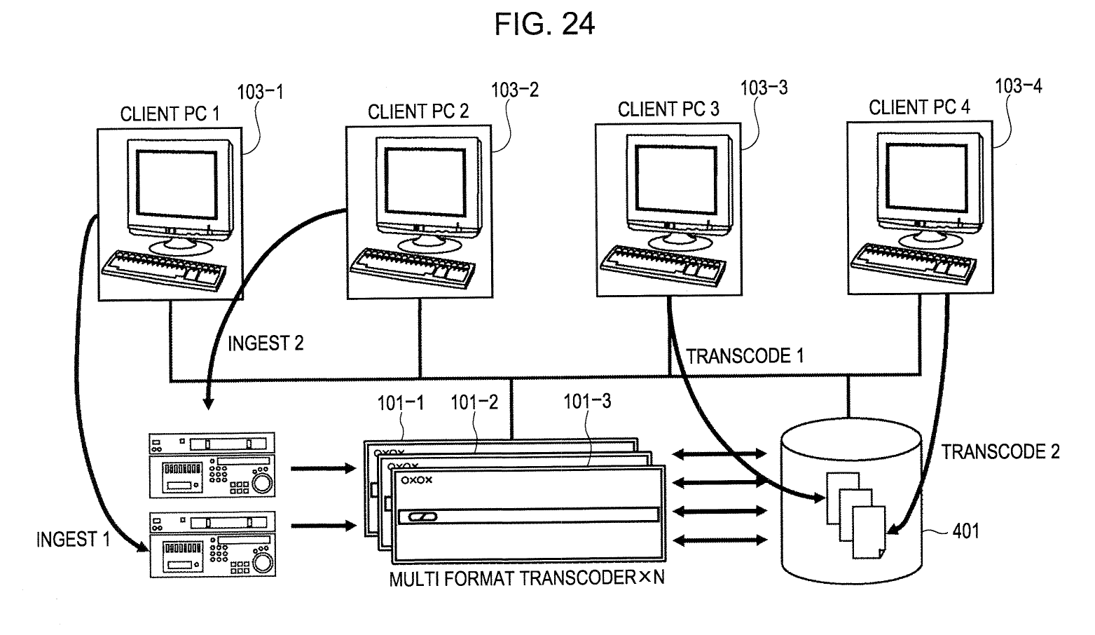

In addition, the conversion system 100 has an arbitrary configuration. For example, as illustrated in FIG. 24, N multi-format transcoders 101 may be configured to operate in cooperation with each other, so that the requests from the plurality of the remote clients may be distributively processed.

Therefore, a load of each multi-format transcoder 101 may be reduced, so that it is possible to process much more tasks at a higher rate.

### [Software]

A series of the aforementioned processes may be executed in a hardware manner or in a software manner. In the case where series of the aforementioned process are executed in a software manner, a program constituting the software is installed from a network or a recording medium.

As illustrated in FIG. 6 or 7, the recording medium is configured as, for example, a removable media 221 or a removable media 321, on which a program is recorded and which is distributed for transmitting the program to a user separately from an apparatus main body, such as a magnetic disk (including a flexible disk), an optical disk (including a CD-ROM (Compact Disc-Read Only Memory) and DVD (Digital Versatile Disc)), an opto-magnetic disk (including MD (Mini Disc)), a semiconductor memory, or the like. In addition, the recording medium is configured as a hard disk or the like included in a ROM 202, a ROM 302, a storage unit 213, or a storage unit 313, on which a program which is to be transmitted to the user in a state of being combined with the apparatus main body in advance is recorded.

In addition, the program executed by a computer may be a program which performs time-series processes in the order described in the specification or a program which performs the processes in parallel or at necessary timings such as a calling time.

In addition, in the specification, a step describing the program recorded on the recording medium includes processes performed in a time series manner in the described order. In addition, the step may include processes performed in parallel or individually instead of being necessarily performed in a time series manner.

In addition, in the specification, a system denotes the entire apparatus that is configured by a plurality of devices (apparatuses).

In addition, hereinbefore, a plurality of apparatuses (or processing units) may be configured by dividing the configuration that is described as one apparatus (or a processing unit). On the contrary, the configuration described hereinbefore as a plurality of the apparatuses (or processing units) may be configured to be assembled as one apparatus (or a processing unit). In addition, a configuration other than the aforementioned configuration may be added to the configuration of each apparatus (or each processing unit). In addition, if the configurations or operations in the entire systems are substantially the same, a portion of the configuration of an apparatus (or a processing unit) may be allowed to be included in the configuration of the other apparatus (or the other processing unit). In other words, the invention is not limited to the aforementioned embodiment, but various modifications may be made within the scope without departing from the spirit of the invention.

The present application contains subject matter related to that disclosed in Japanese Priority Patent Application JP 2009-230942 filed in the Japan Patent Office on Oct. 2, 2009, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
input metadata table acquisition means for acquiring an input metadata table which is a list of items included in a metadata before format conversion;
output metadata table acquisition means for acquiring an output metadata table which is a list of items included in a metadata after the format conversion; and
user map template generation means for generating a user map template which is a template of a conversion pattern of each item of the metadata, which is used for a conversion process of converting the format of the metadata by performing linking between the items included in the input metadata table acquired by the input metadata table acquisition means and the items included in the output metadata table acquired by the output metadata table acquisition means.

2. The information processing apparatus according to claim 1, wherein the user map template generation means generates the user map template by performing the linking on the items of the input metadata table designated by a user and items of the output metadata table designated by the user according to an instruction of the user.

3. The information processing apparatus according to claim 1, further comprising item editing means for performing item editing with respect to the input metadata table acquired by the input metadata table acquisition means or the output metadata table acquired by the output metadata table acquisition means.

4. The information processing apparatus according to claim 1, wherein the user map template generation means generates the user map template by performing the linking of the items by using an automatic map template which is a template in which a conversion pattern of each item of the metadata is defined in advance.

5. The information processing apparatus according to claim 1, wherein the user map template generation means generates the user map template by performing the linking of the items by using the existing user map template.

6. The information processing apparatus according to claim 1, further comprising:
family tree acquisition means for acquiring family tree information representing a structure of a conversion process which converts a format of a clip; and metadata acquisition means for acquiring a metadata of a clip which is designated by using the family tree information acquired by the family tree acquisition means, wherein the user map template generation means generates the user map template by performing the linking between values of the items included in the metadata acquired by the metadata acquisition means and the items included in the output metadata table acquired by the output metadata table acquisition means.

7. The information processing apparatus according to claim 1, further comprising display control means for allowing the items included in the input metadata table acquired by the input metadata table acquisition means, the items included in the output metadata table acquired by the output metadata table acquisition means, and the conversion pattern represented by the user map template generated by the user map template generation means.

8. An information processing method comprising the steps of:
acquiring an input metadata table which is a list of items included in a metadata before format conversion;
acquiring an output metadata table which is a list of items included in a metadata after the format conversion; and
creating a user map template which is a template of a conversion pattern of each item of the metadata, which is used for a conversion process of converting the format of the metadata by performing linking between the items included in the input metadata table acquired by the input metadata table acquisition means and the items included in the output metadata table acquired by the output metadata table acquisition means.

9. An information processing apparatus comprising:
map template acquisition means for acquiring a map template which is a template of a conversion pattern of each item of a metadata corresponding to formats before and after conversion of a conversion process, which converts a format of the metadata; and
conversion means for converting the format of the metadata by using the map template acquired by the map template acquisition means.

10. The information processing apparatus according to claim 9, wherein the map template acquisition means acquires an automatic map template which is a template in which a conversion pattern of each item of the metadata is defined in advance.

11. The information processing apparatus according to claim 9, wherein the map template acquisition means acquires a user map template which is a template in which a conversion pattern of each item of the metadata is defined by a user.

12. An information processing method comprising the steps of:
acquiring a map template which is a template of conversion patterns of items of a metadata, which correspond to formats before and after conversion of a conversion process which converts the formats of the metadata; and
converting the formats of the metadata by using the acquired map template.

13. An information processing apparatus comprising:
an input metadata table acquisition unit which acquires an input metadata table which is a list of items included in a metadata before format conversion;
an output metadata table acquisition unit which acquires an output metadata table which is a list of items included in a metadata after the format conversion; and
a user map template generation unit which generates a user map template which is a template of a conversion pattern of each item of the metadata, which is used for a conversion process of converting the format of the metadata by performing linking between the items included in the input metadata table acquired by the input metadata table acquisition unit and the items included in the output metadata table acquired by the output metadata table acquisition unit.

14. An information processing apparatus comprising:
a map template acquisition unit which acquires a map template which is a template of a conversion pattern of each item of a metadata corresponding to formats before and after conversion of a conversion process, which converts a format of the metadata; and
a conversion unit which converts the format of the metadata by using the map template acquired by the map template acquisition unit.
